(19) United States
(12) Patent Application Publication
(10) Pub. No.: US 2007/0107635 A1
(43) Pub. Date: May 17, 2007

(54) Dye-attached and/or surface modified pigments

(75) Inventors: David Soane, Chestnut Hill, MA (US); Michael C. Berg, Somerville, MA (US); William A. Mowers, Lynn, MA (US)

Correspondence Address: GOODWIN PROCTER LLP;PATENT ADMINISTRATOR, EXCHANGE PLACE, BOSTON, MA, 02109-2881, US

(73) Assignee: Soane Laboratories, LLC, Cambridge, MA (US)

(21) Appl. No.: 11/501,463

(22) Filed: Aug. 9, 2006

Related U.S. Application Data
(60) Provisional application No. 60/712,059, filed on Aug. 29, 2005.
(60) Provisional application No. 60/706,853, filed on Aug. 9, 2005.
(60) Provisional application No. 60/765,117, filed on Feb. 3, 2006.
(60) Provisional application No. 60/725,827, filed on Oct. 11, 2005.

(51) Int. Cl. C08K 5/00

(52) U.S. Cl. 106/493

(57) ABSTRACT

This invention relates generally to dye-attached and/or surface-modified (e.g. functionalized) pigments. Certain embodiments include pigments formed by attaching a dye to the surface of a metal oxide or semi-metal oxide particle. Other embodiments include surface-modified pigments formed by attaching polymers having amine groups to the surface of a pigment. The surface functionalization of pigment particles with polymers having amine groups may provide the pigment with enhanced water resistance, color-fastness, smudge resistance, and/or compatibility with other materials in a composite or matrix material(s). For example, such functionalized pigments may be used in inks, paints, paper, fabrics, coatings, cosmetics, food, or other composites to provide or adjust hydrophobicity, softness, smoothness, and/or oleophobicity.

### PRIOR APPLICATIONS

This application claims benefit of U.S. Provisional Patent Application No. 60/712,059, filed Aug. 29, 2005; U.S. Provisional Patent Application No. 60/706,853, filed Aug. 9, 2005; U.S. Provisional Patent Application No. 60/725,827, filed Oct. 10, 2005; and U.S. Provisional Patent Application No. 60/765,117, filed Feb. 3, 2006, the texts of which are incorporated herein by reference in their entirety.

### FIELD OF THE INVENTION

This invention relates generally to dye-attached and/or surface-modified pigments. More particularly, in certain embodiments, the invention relates to pigments formed by attaching a dye to the surface of a metal oxide or semi-metal oxide particle, as well as surface-modified (e.g. functionalized) pigments formed by attaching polymers having amine groups to the surface of a pigment.

### BACKGROUND OF THE INVENTION

A pigment is a colorant that is typically ground into a powder and mixed with a matrix of relatively neutral or colorless binder material. Different pigments have particles of different sizes, shapes, and/or packing attributes that make them unique and desirable for certain uses. However, pigment particles that are otherwise well-suited for a particular application may not be available in a desired color.

Dyes, on the other hand, are available in a wider range of colors and with a wider array of optical attributes than pigments. A dye is different from a pigment in that a dye is soluble in its matrix (i.e. water or oil). However, dyes may be difficult to work with, since slight variations in dye concentrations may cause noticeable color alterations. Processing with dyes can be very difficult and expensive, since dyes are soluble in their matrix and changing from one color to another requires repeated, extensive cleaning of processing equipment.

A mixture of a pigment and a dye may be prepared. However, this does not address the processing disadvantages associated with dyes, since the dye is still soluble in the matrix.

Furthermore, a pigment (used alone, or in a mixture with a dye) may have difficulty dispersing in the matrix in which it is used due to molecular incompatibility between the pigment and the matrix material. In addition to dispersion problems, the incompatibility between a pigment and matrix material(s) (e.g. binder, diluent, filler, and/or additives) may cause poor physical properties such as low tensile strength, due to repulsion at molecular interfaces.

There is a need for pigments having a wider variety of colors and/or optical properties. Furthermore, there is a need for a pigment with enhanced compatibility with its matrix for improved dispersability and other physical properties.

### SUMMARY OF THE INVENTION

This invention provides pigments that are formed by attaching a dye to the surface of a metal oxide or semi-metal oxide particle using a multifunctional coupling agent. Without being bound to any theory, the multifunctional coupling agent is believed to bond with both a surface hydroxyl group on the particle as well as a reactive moiety of the dye, thereby imbuing the pigment particle with the desired color properties of the dye while retaining the desired physical properties of the pigment particles.

Furthermore, these pigments, as well as other pigments, may be modified by attaching polymers to the surface of the pigment particles. The surface modification (e.g. functionalization) of pigment particles with polymers having amine groups (charged and/or uncharged), for example, may allow the enhancement and/or tunability of pigment properties, such as water resistance, color-fastness, smudge resistance, and/or compatibility with matrix material(s) (e.g. binder, diluent, filler, and/or additives).

Furthermore, such functionalized pigments may be used in inks, paints, paper, coatings, fabrics, cosmetics, or other composites to provide or adjust hydrophobicity, softness, smoothness, and/or oleophobicity. Functionalized pigments may be used in paper, coatings, fabrics, or cosmetics for enhanced dispersion of pigment therein. Functionalized pigments may also be used in oil-based or water-based paints or inks, providing enhanced compatibility between the pigment and the matrix material(s).

Moreover, the use of certain small particle sizes provide pigments having improved optical properties such as absorbance, scattering, opacity, hue, value (lightness), and/or chroma. In certain embodiments, the use of a brine solution and/or the use of multiple solvents provide enhanced loading of dye onto the surface of the particles.

In one aspect, the invention relates to a pigment including a particle with a dye attached to its surface via a multifunctional coupling agent, wherein the particle is less than about 10 μm in at least one dimension, the particle including a metal oxide, a semi-metal oxide, or both. In one embodiment, the particle is less than about 1 μm in diameter. In one embodiment, the particle is less than about 200 nm in diameter. In certain embodiments, the particle is greater than about 1 μm in at least one dimension (for example, diameter), greater than about 5 μm in at least one dimension (for example, diameter), or greater than about 10 μm in at least one dimension (for example, diameter).

The coupling agent may covalently link the dye to the particle surface. Alternatively, the coupling agent bonding to the dye and/or the particle surface may be covalent, non-covalent, and/or ionic. The attachment of the dye to the particle surface via the coupling agent may alternatively or additionally be via Van der Waals forces, hydrogen bonds, and/or other intermolecular forces.

The particle may include an oxide of Si, Sn, An, Ti, Bi, Fe, Zr, and/or Zn. In certain embodiments, the particle is or includes kaolin, a silicate, silicon dioxide, titanium dioxide, diatomaceous earth, borosilicate, alumina, ferric oxide, clay, mica, talc, calcium carbonate, a zeolite, glass and/or nacreous pigment. In certain embodiments, the particle may include an oxide and/or a hydroxide of Si, Sn, An, Ti, Bi, Fe, Zr, and/or Zn. The particle may be transparent or non-transparent. For example, in certain embodiments, chromium oxides and/or hydroxides are present in nacreous pigments and are approved cosmetic colorants.

Nacreous pigments, also known as pearlescent or effect pigments, are based on the use of a laminar substrate of platelet such as mica or glass flake which has been overcoated with metal oxide, semi-metal oxide, metal hydroxide, or semi-metal hydroxide. These pigments exhibit pearl-like luster as a result of reflection and refraction of light, and depending on the thickness of the metal oxide layer, they may also exhibit interference color effects.

Any encapsulatable smooth and transparent platelet may be used as the particle in the present invention. Examples of useable platelets include mica, whether natural or synthetic, kaolin, glass flakes, Al₂O₃, silica, and the like. The substrate need not be totally transparent but should, preferably, have at least about 75% transmission. The size of the platelet shaped substrate is not critical per se and can be adapted to the particular use. Generally, the particles have largest major dimensions averaging from about 3 to about 200 microns, preferably from about 5 to about 100 microns, a minor dimension from about 0.2 to about 10 microns, and/or an aspect ratio of major to minor dimensions of at least about 5 to 1. Their specific free surface area (BET) is, in general, from about 0.2 to 25 m²/g.

The layers encapsulating the substrate may alternate between high refractive index materials and low refractive index materials. High refractive index materials include those with a refractive index from about 2.00 to about 3.10. Low refractive index materials include those with a refractive index from about 1.30 to about 1.80. The high refractive index materials may be anatase titanium dioxide, rutile titanium dioxide, iron oxide, zirconium dioxide, zinc oxide, zinc sulfide, bismuth oxychloride or the like. The CRC Handbook of Chemistry and Physics, 63^{rd} edition reports refractive indices for these high refractive index materials as follows.

The layers encapsulating the substrate may alternate between high refractive index materials and low refractive index materials. High refractive index materials include those with a refractive index from about 2.00 to about 3.10. Low refractive index materials include those with a refractive index from about 1.30 to about 1.80. The high refractive index materials may be anatase titanium dioxide, rutile titanium dioxide, iron oxide, zirconium dioxide, zinc oxide, zinc sulfide, bismuth oxychloride or the like. The CRC Handbook of Chemistry and Physics, 63^{rd} edition reports refractive indices for these high refractive index materials as follows:

| Material | Refractive Index |
|---|---|
| TiO2 - anatase | 2.55 |
| TiO2 - rutile | 2.90 |
| Fe2O3 - hematite | 3.01 |
| ZrO2 | 2.20 |
| ZnO | 2.03 |
| ZnS | 2.38 |
| BiOCl | 2.15 |

The low refractive index material may be silicon dioxide, magnesium fluoride, aluminum oxide, a polymer such as polymethyl methacrylate, polystyrene, ethylene vinyl acetate, polyurea, polyurethane, polydivinyl benzene and the like.

The CRC Handbook of Chemistry and Physics, 63^{rd} edition reports refractive indices for these low refractive index materials as follows:

| Material | Refractive Index |
|---|---|
| SiO2 - amorphous | 1.46 |
| MgF2 | 1.39 |
| Al2O3 | 1.76 |
| Polymers | 1.4-1.6 is typical |

Any combination of materials may be selected provided that adjacent layers differ in refractive index by at least about 0.2, and more preferably at least about 0.6. The materials are transparent but may, like iron oxide and chromium oxide, have an absorption component.

In certain embodiments, the particle is a nanoparticle. As used herein, a nanoparticle is less than about 100 nm in at least one dimension.

The particle preferably includes surface hydroxyl groups, for example, with which the coupling agent reacts/attaches. The multifunctional coupling agent may include a silicon-containing coupling agent and at least one of the following functional groups: an amino group, an epoxy group, a hydroxyl group, a thiol group, an acrylate group, a carboxyl group, and/or an isocyano group. In one embodiment, the multifunctional coupling agent is a silane coupling agent. In another embodiment, the coupling agent does not include silicon (e.g. in embodiments in which silicon is not used). In certain embodiments, the multifunctional coupling agent includes an isocyanosilane, for example, a trialkoxy isocyanosilane such as trimethoxy isocyanosilane, triethoxy isocyanosilane, and/or triisopropoxy isocyanosilane. In certain embodiments, the multifunctional coupling agent includes an aminosilane, for example, a trialkoxy aminosilane such as triethoxy aminopropylsilane and/or trimethoxy aminopropyl silane. In certain embodiments, the multifunctional coupling agent includes an epoxy siloxane. The multifunctional coupling agent may include triethoxy methacryloxypropyl silane.

In certain embodiments, the dye includes a halotriazine, for example, a chlorotriazine. The dye may include a vinyl sulfone. The dye is preferably a reactive dye. In certain embodiments, the dye includes one or more of the following: a monohalogenotriazine, a dihalogenotrizine, a carboxypyridinium-substituted triazine, a trihalogenopyrimidizine, and/or a dichloroquinoxaline. The dye may include one or more of the following: a fluorescent dye, a phosphorescent dye, a photochromic dye, a thermochromic dye, a whitener, a brightener, a light stabilizer, and/or a UV light stabilizer.

The particle may additionally have one or more of the following agents attached to its surface: a light stabilizer, a UV light stabilizer, a hindered amine light stabilizer, and/or a free radical scavenger. In one embodiment, the agent is attached to the particle surface with a hydroxy phenyl ketone and/or a succinic anhydride derivative, for example, an alkyl succinic anhydride, an alkenyl succinic anhydride, and/or a corresponding carboxylic acid. The pigment may include a plurality of particles, at least one of which has one or more of the following agents attached to its surface: a light stabilizer, a UV light stabilizer, a hindered amine light stabilizer, and/or a free radical scavenger.

In another aspect, the invention relates to a pigment including a particle with a dye attached to its surface via a first multifunctional coupling agent, the particle also having a polymer attached to its surface, wherein the particle is: (i) directly deposited onto the particle surface; and/or (ii) attached to the particle surface via the first multifunctional coupling agent (e.g. a different molecule of the same chemical species as the coupling agent attaching the dye to the particle surface); and/or (iii) attached to the particle surface via a second multifunctional coupling agent (e.g. a different type of chemical species than the coupling agent attaching the dye to the particle surface). The description of embodiments above can be applied to this aspect of the invention as well.

In certain embodiments, the particle is a metal oxide, a semi-metal oxide, or both. As used herein, a semi-metal oxide is an oxide comprising an atom of a semi-metallic element, for example, Si, As, Sb, and/or Bi. In one embodiment, the particle is less than about 1 μm in diameter. In one embodiment, the particle is less than about 200 nm in diameter.

The first coupling agent may covalently link the dye to the particle surface. Alternatively, the first coupling agent bonding to the dye and/or the particle surface may be covalent, non-covalent, and/or ionic. The attachment of the dye to the particle surface via the first coupling agent may alternatively or additionally be via Van der Waals forces, hydrogen bonds, and/or other intermolecular forces. The second coupling agent may covalently link the polymer to the particle surface. Alternatively, the second coupling agent bonding to the polymer and/or the particle surface may be covalent, non-covalent, and/or ionic. The attachment of the polymer to the particle surface via second coupling agent may alternatively or additionally be via Van der Waals forces, hydrogen bonds, and/or other intermolecular forces. It is possible that there is no second coupling agent needed and that moieties of the polymer bond or otherwise attach to moieties of the first coupling agent (attached to the particle surface), and/or moieties of the polymer bond or otherwise attach to moieties present on the surface of the particle (e.g. hydroxyl groups).

The particle may include an oxide of Si, Sn, An, Ti, Bi, Fe, Zr, and/or Zn. In certain embodiments, the particle is or includes kaolin, a silicate, silicon dioxide, titanium dioxide, diatomaceous earth, borosilicate, alumina, ferric oxide, clay, mica, talc, calcium carbonate, a zeolite, and/or nacreous pigment.

In certain embodiments, the particle is a nanoparticle. As used herein, a nanoparticle is less than about 100 nm in at least one dimension.

The particle preferably includes surface hydroxyl groups, for example, with which a coupling agent reacts/attaches. Either or both of the first and second multifunctional coupling agents may include Si and may include at least one of the following functional groups: an amino group, an epoxy group, a hydroxyl group, a thiol group, an acrylate group, a carboxyl group, and/or an isocyano group. In one embodiment, either or both of the first and second multifunctional coupling agents include a silane coupling agent. In another embodiment, either or both of the first and second multifunctional coupling agents do not include Si (e.g. in embodiments in which Si is not used). In certain embodiments, either or both of the first and second multifunctional coupling agents include an isocyanosilane, for example, a trialkoxy isocyanosilane such as trimethoxy isocyanosilane, triethoxy isocyanosilane, and/or triisopropoxy isocyanosilane. In certain embodiments, either or both of the first and second multifunctional coupling agents include an aminosilane, for example, a trialkoxy aminosilane such as triethoxy aminopropylsilane and/or trimethoxy aminopropyl silane. In certain embodiments, either or both of the first and second multifunctional coupling agents include an epoxy siloxane. Either or both of the first and second multifunctional coupling agents may include triethoxy methacryloxypropyl silane.

In certain embodiments, the dye includes a halotriazine, for example, a chlorotriazine. the dye may include a vinyl sulfone. The dye is preferably a reactive dye. In certain embodiments, the dye includes one or more of the following: a monohalogenotriazine, a dihalogenotrizine, a carboxypyridinium-substituted triazine, a trihalogenopyrimidizine, and/or a dichloroquinoxaline. The dye may include one or more of the following: a fluorescent dye, a phosphorescent dye, a photochromic dye, a thermochromic dye, a whitener, a brightener, a light stabilizer, and/or a UV light stabilizer.

The particle may additionally have one or more of the following agents attached to its surface: a light stabilizer, a UV light stabilizer, a hindered amine light stabilizer, and/or a free radical scavenger. In one embodiment, the agent is attached to the particle surface with a hydroxy phenyl ketone and/or a succinic anhydride derivative, for example, an alkyl succinic anhydride, an alkenyl succinic anhydride, and/or a corresponding carboxylic acid. The pigment may include a plurality of particles, at least one of which has one or more of the following agents attached to its surface: a light stabilizer, a UV light stabilizer, a hindered amine light absorber, and/or a free radical scavenger.

The polymer attached to the particle preferably includes an amine group, an amino group, and/or an imine group. For example, the polymer may include (or be) one or more of the following: polyethyleneimine, linear polyethyleneimine, branched polyethyleneimine, poly(allyl amine), poly(vinyl amine), and/or chitosan. The polymer may include (or be) a protein. The polymer may include a carboxyl group. The polymer may include one or more of the following: polyacrylic acid, polymethacrylic acid, carboxymethylcellulose, pectin, and/or xanthan gum. The polymer may include one or more of the following: poly(vinyl alcohol), polyethylene glycol, and/or a polysaccharide.

In one embodiment, the particle includes an oxide of Si, Sn, Al, Ti, and/or Bi; the first multifunctional coupling agent includes Si and one or more of the following functional groups: an amino group, an epoxy group, a hydroxyl group, a thiol group, an acrylate group, a carboxyl group, and/or an isocyano group; and the dye includes one or more of the following: a halogenotriazine, a monohalogenotriazine, a dihalogenotrizine, a carboxypyridinium-substituted triazine, a trihalogenopyrimidizine, a vinyl sulfone, and/or a dichloroquinoxaline.

In one embodiment, the polymer is directly deposited onto the particle surface via precipitation and/or titeration. For example, the polymer may be a film-forming polymer.

In yet another aspect, the invention relates to a method for preparing a functionalized pigment, the method including the steps of: attaching a reactive dye to a surface of a particle using a first multifunctional coupling agent; and attaching a polymer to the surface of the particle, wherein the polymer is: (i) directly deposited onto the particle surface; and/or (ii) attached to the particle surface via the first multifunctional coupling agent (e.g. a different molecule of the same chemical species as the coupling agent attaching the dye to the particle surface); and/or (iii) attached to the particle surface via a second multifunctional coupling agent (e.g. a different type of chemical species than the coupling agent attaching the dye to the particle surface). The description of embodiments above can be applied to this aspect of the invention as well.

In certain embodiments, the particle is a metal oxide, a semi-metal oxide, or both. In one embodiment, the particle is less than about 1 μm in diameter. In one embodiment, the particle is less than about 200 nm in diameter.

The first coupling agent may covalently link the dye to the particle surface. Alternatively, the first coupling agent bonding to the dye and/or the particle surface may be covalent, non-covalent, and/or ionic. The attachment of the dye to the particle surface via the first coupling agent may alternatively or additionally be via Van der Waals forces, hydrogen bonds, and/or other intermolecular forces. The second coupling agent may covalently link the polymer to the particle surface. Alternatively, the second coupling agent bonding to the polymer and/or the particle surface may be covalent, non-covalent, and/or ionic. The attachment of the polymer to the particle surface via second coupling agent may alternatively or additionally be via Van der Waals forces, hydrogen bonds, and/or other intermolecular forces. It is possible that there is no second coupling agent needed and that moieties of the polymer bond or otherwise attach to moieties of the first coupling agent (attached to the particle surface), and/or moieties of the polymer bond or otherwise attach to moieties present on the surface of the particle (e.g. hydroxyl groups).

The particle may include an oxide of Si, Sn, An, Ti, Bi, Fe, Zr, and/or Zn. In certain embodiments, the particle is or includes kaolin, a silicate, silicon dioxide, titanium dioxide, diatomaceous earth, borosilicate, alumina, ferric oxide, clay, mica, talc, calcium carbonate, a zeolite, and/or nacreous pigment.

In certain embodiments, the particle is a microparticle or a nanoparticle. As used herein, a microparticle is less than about 100 μm in at least one dimension and a nanoparticle is less than about 100 nm in at least one dimension.

The particle preferably includes surface hydroxyl groups, for example, with which a coupling agent reacts/attaches. Either or both of the first and second multifunctional coupling agents may include a silicon-containing functional group and at least one of the following: an amino group, an epoxy group, a hydroxyl group, a thiol group, an acrylate group, a carboxyl group, and/or an isocyano group. In one embodiment, either or both of the first and second multifunctional coupling agents include a silane functional group. In another embodiment, either or both of the first and second multifunctional coupling agents do not include a silane functional group (e.g. in embodiments in which silanes cannot be used). In certain embodiments, either or both of the first and second multifunctional coupling agents include an isocyanosilane, for example, a trialkoxy isocyanosilane such as trimethoxy isocyanosilane, triethoxy isocyanosilane, and/or triisopropoxy isocyanosilane. In certain embodiments, either or both of the first and second multifunctional coupling agents include an aminosilane, for example, a trialkoxy aminosilane such as triethoxy aminopropylsilane and/or trimethoxy aminopropyl silane. In certain embodiments, either or both of the first and second multifunctional coupling agents include an epoxy siloxane. Either or both of the first and second multifunctional coupling agents may include triethoxy methacryloxypropyl silane.

In certain embodiments, the dye includes a halotriazine, for example, a chlorotriazine. the dye may include a vinyl sulfone. The dye is preferably a reactive dye. In certain embodiments, the dye includes one or more of the following: a monohalogenotriazine, a dihalogenotrizine, a carboxypyridinium-substituted triazine, a trihalogenopyrimidizine, and/or a dichloroquinoxaline. The dye may include one or more of the following: a fluorescent dye, a phosphorescent dye, a photochromic dye, a thermochromic dye, a whitener, a brightener, a light stabilizer, and/or a UV light stabilizer.

The method may include the step of attaching one or more of the following to the particle surface: a light stabilizer, a UV light stabilizer, a UV blocking compound, an optical brightener (e.g. a stilbene derivative), a hindered amine light absorber, and/or a free radical scavenger. In one embodiment, the agent is attached to the particle surface with a hydroxy phenyl ketone and/or a succinic anhydride derivative, for example, an alkyl succinic anhydride, an alkenyl succinic anhydride, and/or a corresponding carboxylic acid.

The polymer preferably includes an amine group, an amino group, and/or an imine group. For example, the polymer may include (or be) one or more of the following: polyethyleneimine, linear polyethyleneimine, branched polyethyleneimine, poly(allyl amine), poly(vinyl amine), a polyelectrolyte, a biopolymer, and/or chitosan. In certain embodiments, the polymer imparts the surface of the particle with amine functional groups. The polymer may include (or be) a protein. The polymer may include a carboxyl group. The polymer may include one or more of the following: polyacrylic acid, polymethacrylic acid, carboxymethylcellulose, pectin, and/or xanthan gum. The polymer may include one or more of the following: poly(vinyl alcohol), polyethylene glycol, and/or a polysaccharide.

In one embodiment, the method includes directly depositing the polymer onto the particle surface via precipitation and/or titeration. For example, the polymer may be a film-forming polymer.

In certain embodiments, the method includes the step of alternately contacting the surface of the particle with polyelectrolytes of opposite charge, thereby building multiple layers on the surface of the particle.

In one embodiment, the method further includes the step of contacting the particle with a base to promote formation of reactive hydroxyl groups on the surface of the particle.

In one embodiment, the step of attaching the reactive dye to the surface of the particle includes contacting the particle and the dye in the presence of a salt solution (e.g. NaCl, brine), thereby increasing the loading of dye onto the particle surface. In one embodiment, the step of attaching the reactive dye to the surface of the particle includes contacting the particle and the dye in the presence of a plurality of solvents, thereby increasing the loading of dye onto the particle surface. In one embodiment, the step of attaching the reactive dye to the surface of the particle includes contacting the particle and the dye in the presence of water, for example, without salt and without the presence of other solvents. In certain cases, the use of substantially pure water provides optimal loading of the dye onto the surface of the particle via the coupling agent.

In yet another aspect, the invention relates to a pigment including a first particle with a dye attached to its surface via a first multifunctional coupling agent; and a second particle with a polymer attached to its surface, wherein the polymer is: (i) directly deposited onto the particle surface; and/or (ii) attached to the particle surface via the first multifunctional coupling agent (e.g. a different molecule of the same chemical species as the coupling agent attaching the dye to the particle surface); and/or (iii) attached to the particle surface via a second multifunctional coupling agent (e.g. a different type of chemical species than the coupling agent attaching the dye to the particle surface). The description of embodiments above can be applied to this aspect of the invention as well.

In yet another aspect, the invention relates to a pigment including a particle with a polymer attached to its surface, the polymer having a dye attached thereto, wherein the polymer is either directly deposited onto the surface of the particle, or attached to the surface of the particle via a multifunctional coupling agent. The description of embodiments above can be applied to this aspect of the invention as well.

In yet another aspect, the invention relates to a composite pigment comprising a nacreous pigment with a dye attached to its surface via a multifunctional coupling agent. The description of embodiments above can be applied to this aspect of the invention as well.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1A shows two graphs depicting colorimeter readings indicating the effect on pigment color made by the attachment of sun yellow reactive dye to Firemist™ Gold pigment particles via multifunctional coupling agent (3-aminopropyl trimethoxysilane) prepared in Example 30 according to an illustrative embodiment of the invention (colorimeter readings made against a white background).

FIG. 1B shows two graphs depicting colorimeter readings indicating the effect on pigment color made by the attachment of-sun yellow reactive dye to Firemist™ Gold pigment particles via multifunctional coupling agent (3-aminopropyl trimethoxysilane) prepared in Experimental Example 30 according to an illustrative embodiment of the invention (colorimeter readings made against a black background).

FIG. 2A shows two graphs depicting colorimeter readings indicating the effect on pigment color made by the attachment of deep black 609 reactive dye to Firemist™ Pearl pigment particles via multifunctional coupling agent (3-aminopropyl trimethoxysilane) prepared in Experimental Example 31 according to an illustrative embodiment of the invention (calorimeter readings made against a white background).

FIG. 2B shows two graphs depicting colorimeter readings indicating the effect on pigment color made by the attachment of deep black 609 reactive dye to Firemist™ Pearl pigment particles via multifunctional coupling agent (3-aminopropyl trimethoxysilane) prepared in Experimental Example 31 according to an illustrative embodiment of the invention (colorimeter readings made against a black background).

FIG. 3A shows two graphs depicting calorimeter readings indicating the effect on pigment color made by the attachment of PRO Intense Blue 406 MX reactive dye to Firemist™ Pearl pigment particles via multifunctional coupling agent (3-aminopropyl trimethoxysilane) prepared in Experimental Examples 32, 33, and 34 according to an illustrative embodiment of the invention (calorimeter readings made against a white background).

FIG. 3B shows two graphs depicting calorimeter readings indicating the effect on pigment color made by the attachment of PRO Intense Blue 406 MX reactive dye to Firemist™ Pearl pigment particles via multifunctional coupling agent (3-aminopropyl trimethoxysilane) prepared in Experimental Examples 32, 33, and 34 according to an illustrative embodiment of the invention (colorimeter readings made against a white background).

FIG. 4 shows a graph depicting Thermal Gravimetric Analysis of two samples—(i) product of reaction of silane coupling agent, sun yellow 109 dye, and Firemist™ Gold (prepared in Experimental Example 37); and (ii) product of reaction of silane coupling agent, Cibacron Red FN-2BL dye, and Firemist™ Pearl pigment particles (prepared in Experimental Example 38)—indicating mass loss with increasing temperature, according to an illustrative embodiment of the invention.

FIG. 5 shows a graph depicting Thermal Gravimetric Analysis of two samples—(i) product of reaction of 10% silane coupling agent, 0.65 eq. Cibacron Black W-RKM dye, and Magna Pearl 3100 particles (prepared in Experimental Example 35; and (ii) product of reaction of 10% silane coupling agent, 0.25 eq. Cibacron Black W-RKM dye, and Magna Pearl 3100 particles (prepared in Experimental Example 36)—indicating mass loss with increasing temperature, according to an illustrative embodiment of the invention.

### DETAILED DESCRIPTION

It is contemplated that methods, systems, and processes of the claimed invention encompass variations and adaptations developed using information from the embodiments described herein.

Throughout the description, where products, systems, formulations, compositions, mixtures, and blends are described as having, including, or comprising specific components, or where processes and methods are described as having, including, or comprising specific steps, it is contemplated that, additionally, there are products, systems, formulations, compositions, mixtures, and blends of the present invention that consist essentially of, or consist of, the recited components, and that there are processes and methods of the present invention that consist essentially of, or consist of, the recited processing steps.

The mention herein of any publication, for example, in the Background section, is not an admission that the publication serves as prior art with respect to any of the claims presented herein. The Background section is presented for purposes of clarity and is not meant as a description of prior art with respect to any claim.

In certain embodiments, the invention provides pigments made by attaching a dye to a pigment particle via a multifunctional coupling agent which bonds with both a surface hydroxyl group on the particle as well as a reactive moiety of the dye. As used herein, “attaching” includes providing attachment via covalent bonds, non-covalent bonds, Van der Waals forces, hydrogen bonds, and/or other intermolecular forces. A dye may be attached to a pigment particle surface via a coupling agent and/or a linker (e.g. a linker may link a dye to a coupling agent that reacts with a surface hydroxyl group of a pigment particle).

Functionalized pigments include a pigment particle with a polymer attached, wherein the polymer has amine, amino, and/or imine groups. Polymers comprising amine groups may include primary (—NH₂R), secondary (—NHR₂), and/or tertiary amine (—NR₃) groups. Such polymers may include a quaternary ammonium cation or may be a quaternary ammonium salt. The amine groups may include charged and/or uncharged groups.

In some embodiments, a pigment particle with an attached polymer may be treated or washed with an acidic solution or compound, such as an acidic solution comprising an inorganic acid, to create a charged amine group and/or a stable salt complex. Such polymers may be in the form of an amine salt, and may include salts formed with formic, acetic, succinic, citric, lactic, maleic, fumaric, palmitic, cholic, pamoic, mucic, d-glutamic, d-camphoric, glutaric, glycolic, phthalic, tartaric, lauric, stearic, salicyclic, methanesulfonic, benzenesulfonic, paratoluenesulfonic, sorbic, puric, benzoic, cinnamic and the like organic acids. A particular polymer may be in the form of an amine hydrochloric acid salt. An acidic solution for use may be at a concentration that facilitates the formation of the charged amine group, but may not be at a concentration that would remove the amine group or other moieties from the polymer.

Polymers for use in the functionalized pigments herein include glycoaminoglycans such as polysaccharides, gums, starch or cationic derivatives thereof, that include an amine group. For example, such polymers may include chitosan, hyaluronic acid, chrondoitin sulfate, and certain proteins or polypeptides. As used herein, “polysaccharide” is understood to mean a biological polymer having sugar subunits, for example, a starch or a cellulose, or a derivative of such a biological polymer, for example, chitosan, pectin, or carboxymethyl cellulose.

Other polymers for use in the functionalized pigments herein include polyalkyleneamines (PAA) such as tetrabutylenepentamine, polyalkyleneimines (PAI), polyethyleneamine (PEA) such as triethylenetetramine (TETA) and teraethylenepentamine (TEPA), and polyethyleneimines (PEI) such as linear polyethyleneimine (LPEI), branched polyethyleneimine (BPEI), polyallylamines, and polyvinylamines. Branched polyethylenimine, for example, may have at least moderate branching. In certain embodiments, film-forming polymers are used, which facilitates attachment of the polymer onto the particles (e.g. “wrapping” of the polymer onto the particles).

Still other polymers that can be used in the functionalized pigments herein include such polymers as poly(amido-amine) dendrimers, poly(alkylamino-glucaramide), and linear polymers with a single primary, secondary or tertiary amine group attached to the polymer units, such as poly(dimethylaminoethyl methacrylates), dimethylamino dextran, and polylysines.

The polymers may be attached to the particles by covalent bonds, non-covalent bonds, and/or attached via Van der Waals forces, hydrogen bonds, and/or other intermolecular forces. A polymer may be attached to a pigment particle surface via a coupling agent and/or a linker (e.g. a linker may tether a polymer to a coupling agent that reacts with a surface hydroxyl group of a pigment particle).

In certain embodiments, the dye includes a halotriazine, for example, a chlorotriazine. the dye may include a vinyl sulfone. The dye is preferably a reactive dye. As used herein, the term “reactive dye” includes a chromophore containing one or more moieties that is/are capable of reacting with or otherwise attaching to a substrate, for example, a fiber substrate or, in certain embodiments described herein, a particle. In certain embodiments, the dye includes one or more of the following: a monohalogenotriazine, a dihalogenotrizine, a carboxypyridinium-substituted triazine, a trihalogenopyrimidizine, and/or a dichloroquinoxaline. The dye may include one or more of the following: a fluorescent dye, a phosphorescent dye, a photochromic dye, a thermochromic dye, a whitener, a brightener, a light stabilizer, and/or a UV light stabilizer.

Dyes that may be used in certain embodiments include, for example, acridine dyes; anthraquinone dyes; arylmethane dyes such as diaryl methane dyes and triarylmethane dyes; azo dyes; cyanine dyes; diazonium dyes including salts thereof; nitro dyes; ditroso dyes; phthalocyanine dyes; quinone-imine dyes, for example, azin dyes such as eurhodin dyes and safranin dyes, indamins, indophenols, oxazin dyes, oxazone dyes, and thiazin dyes; thiazole dyes; and xanthene dyes such as fluorene dyes (e.g. pyronin dyes and rhodamine dyes) and fluorone dyes. These and other dyes that may be used in certain embodiments may be classified in one or more of the following categories: reactive dyes, acid dyes, basic dyes, direct or substantive dyes, mordant dyes, vat dyes, reactive dyes, disperse dyes, azo dyes, oxidation bases, sulfur dyes, leather dyes, fluorescent brighteners, solvent dyes, and carbene dyes.

The pigment particle used to make functionalized pigments may be any of the dye-attached metal oxide and/or semi-metal oxide particles described herein. The pigment particle may also be any known pigment, including biological pigments such as alizarin, alizarin crimson, gamboge, indigo, indian yellow, cochineal red, and tyrian purple; carbon pigments such as carbon black, ivory black, vine black, and lamp black; cadmium pigments such as cadmium green, cadmium red, cadmium yellow, and cadmium orange; iron oxide pigments such as caput mortuum, oxide red, red ochre, sanguine, venetian red, and mars black; chromium pigments such as chrome green and chrome yellow; cobalt pigments such as cobalt blue and cerulean blue; lead pigments such as lead white, naples yellow, cremnitz white, and red lead; copper pigments such as paris green, verdigris, and viridian; titanium pigments such as titanium white and titanium beige; ultramarine pigments such as ultramarine, ultramarine green shade, and french ultramarine; mercury pigments such as vermilion; zinc pigments such as zinc white; clay earth pigments such as raw sienna, burnt sienna, raw umber, burnt umber, and yellow ochre; and organic pigments such as pigment red 170, phthalo green, phthalo blue, prussian blue, and quinacridone magenta. In certain embodiments, nacreous (pearlescent) pigment particles are used, for example, titanium dioxide-coated mica or glass, as well as iron oxide-coated mica or glass.

Pigment particles functionalized with polymers having amine groups (charged and/or uncharged) enhances the compatibility of the pigment with matrix material(s) in which the pigment is used (e.g. binder, diluent, filler, and/or additives). Binders include, for example, synthetic and/or natural resins such as acrylics, polyurethanes, polyesters, melamines, epoxy, and/or oils. Diluents include, for example, water, volatile low-molecular weight synthetic resins, or organic solvents such as petroleum distillate, alcohols, ketones, esters, glycol ethers, and the like. Fillers include, for example, talc, lime, baryte, bentonite clay, and the like. Additives include, for example, other pigments, dyes, catalysts, thickeners, stabilizers, emulsifiers, texturizers, adhesion promoters, flatterners (e.g. de-glossing agents), and the like.

In certain embodiments, the pigments described herein are composed of a metal oxide where surface hydroxyl groups can react with a silane coupling agent. For example, the particles may be silacious, tin or alumina oxides. Certain material properties that are desired for the final product can be tuned according to the properties of the core particle of the pigment. For example, the size and shape of the core particles may be chosen to provide desired material properties of the final pigment. This provides much more versatility, since a dye can be selected which, when attached to a particle having the desired size and shape for a given application, provides almost any color or other desired optical property to the final pigment.

Advantageous dye loadability and accompanying intensity of color may be provided where the average particle size is less than or equal to about 1 micrometer in diameter, or less than or equal to about 200 nm in diameter, or less than or equal to about 100 nm in average diameter, depending on various factors, for example, the composition of the particle and its surface functionalization. Microparticles and nanoparticles having a desired color or optical property may not be currently available. However, it is possible to obtain nanoparticle pigments having desired optical properties by using multifunctional coupling agents described herein to attach a reactive dye to available nano-clay or nano-silica particles.

The use of certain small particle sizes provide pigments having improved optical properties such as absorbance, scattering, opacity, hue, value (lightness), and/or chroma. For example, improvements may be quantified using the L*a*b* color space, where L* defines lightness/darkness, a* defines greenness/redness, and b* defines yellowness/blueness. The improved optical properties may correlate with the increased particle surface area available for dye to attach, via the coupling agent. In certain embodiments, improvement in optical properties is achieved where the particle is less than about 1 μm in at least one dimension. In one embodiment, improvements are achieved where the particle is less than about 1 μm in diameter. In one embodiment, improvements are achieved where the particle is less than about 200 nm in diameter. In certain embodiments, the particles have an average particle size (or D50 as shown in Table 1 below) of less than about 1 μm, less than about 800 nm, less than about 600 nm, less than about 400 nm, less than about 200 nm, less than about 100 nm, less than about 50 nm, less than about 20 nm, less than about 15 nm, less than about 10 nm, or less than about 5 nm, where “size” can mean either the largest dimension (e.g. length of platelet), smallest dimension (e.g. thickness of platelet), diameter, or other particle dimension. Of course, it is possible to prepare particles larger than those described above having advantageous optical properties, per various embodiments described herein.

The particles may be substantially spherical, cylindrical, and/or amorphous, for example. The particles may be in the form of pastilles, flakes, spheres, and/or platelets, for example. The particles may have any other geometry.

In one example, diatomaceous earth may be used as the particle core to provide a pigment having desired porosity. In another example, kaolin platelets may be used as the particle to provide for increased barrier properties. In other examples, mica, glass flake, or oxide coated platelets may be used as a substrate for accepting composite dye coatings.

After choosing a core particle, the color is then chosen. The color is chosen from the myriad of colors that are offered from reactive dyes. Reactive dyes are known in the textile industry as versatile dyes that react to the fiber to yield a covalently attached dye to the surface. The reactive dye can be any one of several reactive species such as, but not limited to, those having vinyl sulfones or halotriazine (e.g. chlorotriazine) reactive moieties. This moiety may react with an available moiety of a coupling agent attached to the surface of the particle, or the moiety may react with a polymer, a linker, or some other species that is attached to or otherwise associated with the surface of the particle. Several illustrative, non-limiting methods are described below.

Illustrative Method 1: A coupling agent, for example, a hydrolysable silane or a hydroxyl silane with at least one alkyl group, can be used to react with a moiety of a reactive dye, for example, a triazine group. The hydrolysable group of the coupling agent can be an alkoxy, halo or hydroxyl group that reacts with the surface of the pigment particle to yield a M-O-M bond (or other link), where the M is a metal or semi-metal atom such as silicon, tin or aluminum for example. For example, a chlorotriazine group can react with many moieties such as, but not limited to, a primary amine, a secondary amine, and/or an alcohol group. A coupling agent with an amine functional group is advantageous, since such coupling agents are inexpensive and demonstrate excellent reactivity, as well as excellent final pigment product stability.

The reaction between the amine group of the coupling agent and the chlorotriazine functional group of the dye occurs under mild conditions. The reaction can therefore be carried out in water, which can be used as the solvent and as a reactant for the hydrolysis step. Textile dyes are water soluble and are designed to be reactive toward cellulosic fibers at low temperatures and in water. These dyes are more reactive toward the amine group in 3-aminopropyl triethoxysilane, for example, and do not require heat. The reaction can be carried out in other solvents, such as an alcohol, as desired. A base such as triethyl amine or ammonium hydroxide can be used to aid in the reaction and capture the hydrochloric acid byproduct. A base can also be used to aid in surface activation of the core particle.

Illustrative Method 2: In addition to using a coupling agent, a polymer containing amine groups, such as the glycoaminoglycans and other amine-containing polymers described above, can be used to attach a reactive dye to a metal-oxide or semi-metal oxide particle. For example, if toxicity of the coupling agent is a concern, or if the substrate does not have the appropriate chemistry for reaction to a coupling agent, then an edible glycoaminoglycan (or other amine-containing polymer) can be used. Here the polymer is precipitated or triterated onto the surface of the particles via a change in the pH or other technique. The polymer imparts the surface of the particles with amine functional groups, which can act as a chemical handle in the same manner as the coupling agent. The polymer can be added in various thicknesses by altering the solution concentration prior to increasing the pH and precipitation of the polymer. After placing the polymer onto the substrate the amines are then accessible for reaction with the reactive dye.

Illustrative Method 3: A coupling agent attaches to the surface of the pigment and then a “linker” is used to tether the reactive dye to the coupling agent, where the linker acts as a spacer group between the reactive dye and the coupling agent. For example, an isocyanate coupling agent can react with a polyalkylamine “linker” to impart the surface of core particles with free amines which in turn can be used to react with the reactive dye to achieve the desired effect.

Functionalized Pigments: In one embodiment, a surface-modified (functionalized) pigment is created by first performing Illustrative Method 1 above to attach dye to particles, then by using an additional coupling agent for attachment of another dye, a polymer, or another chemical moiety to the surface of the particles.

The first step is to choose a particle core along with a color. Then using Illustrative Method 1, a first coupling agent is used to covalently attach the dye to the particle surface. The particles are separated and washed, then contacted with a second coupling agent chosen depending on the functionality to be added to the particle surface.

For example, where the additional functionality is a polymer such as branched polyethylene imine (BPEI), the second coupling agent can be an isocyanate. After contacting with isocyanate, the particles are contacted with BPEI to attach the BPEI to the surface of the particles via the isocyanate coupling agent.

In another example, where the additional functionality is an acrylate, the second coupling agent can be a 3-aminopropyl coupling agent. After contacting with 3-aminopropyl coupling agent, the particles are contacted with an acrylate to attach the acrylate to the surface of the particles via the 3-aminopropyl coupling agent.

In these two examples, the BPEI and the acrylate layers allow the particle to more seamlessly integrate/disperse within a matrix or composite material.

In another example, the additional functionality to be added is another dye. Multiple dyes may be used, for example, where one dye is not thermally stable. Layering a more heat-stable dye on top of a less heat-stable dye may provide better color stability.

Multiple layers may be added, depending on the desired properties of the particles. In certain embodiments, layers of different charge may be stacked (anionic layer on top of a cationic layer, etc.). Multiple layers may provide more stability, protecting layers underneath.

For each coupling agent that is reacted to the surface, an additional two hydrolysable groups remain for interaction with another coupling agent. For example, after applying Illustrative Method 1, another coupling agent may be employed to attach moieties such as epoxides or acrylate groups to the particles by using a coupling agent with such chemistry such as triethoxy methacryloxypropyl silane to add the acrylate functionality. The addition of such moieties to the particles may be performed to impart physical changes, such as hydrophobicity, hydrophilic, oleophobic, and/or olephilicity. The attachment of polymers may also provide improved adhesion or dispersability, or may impart further color chemistry, UV absorption, chemical scavenging, or hindered amine light stabilization. The chemistries can be chosen to create a simple, one step particulate to simplify the end formulation and optimize the properties of the composite or matrix in which it is used.

Pigments described herein (e.g. dye-attached and/or surface-modified pigments) may be used in coatings including solvent and water borne automotive paint systems. Products of this invention have an unlimited use in all types of automotive and industrial paint applications, especially in the organic color coating and inks field where deep color intensity is required. For example, these pigments may be used in mass tone or as styling agents to spray paint all types of automotive and non-automotive vehicles. Similarly, they may be used on all clay/formica/wood/glass/metal/enamel/ceramic and non-porous or porous surfaces. The pigments can be used in powder coating compositions. They can be incorporated into plastic articles geared for the toy industry or the home. These pigments can be impregnated into fibers to impart new and esthetic coloring to clothes and carpeting. They can be used to improve the look of shoes, rubber and vinyl/marble flooring, vinyl siding, and all other vinyl products. In addition, these colors can be used in all types of modeling hobbies.

Examples of compositions known in the art in which the dye-attached and/or surface-functionalized pigments described herein may be used include printing inks, nail enamels, lacquers, thermoplastic and thermosetting materials, natural resins and synthetic resins. Some non-limiting examples include polystyrene and its mixed polymers, polyolefins, in particular, polyethylene and polypropylene, polyacrylic compounds, polyvinyl compounds, for example polyvinyl chloride and polyvinyl acetate, polyesters and rubber, and also filaments made of viscose and cellulose ethers, cellulose esters, polyamides, polyurethanes, polyesters, for example polyglycol terephthalates, and polyacrylonitrile.

In the cosmetic and personal care field, these pigments may be used in all external and rinse-off applications. Thus, they may be used in hair sprays, face powder, leg-makeup, insect repellent lotion, mascara cake/cream, nail enamel, nail enamel remover, perfume lotion, and shampoos of all types (gel or liquid). In addition, they can be used in shaving cream (concentrate for aerosol, brushless, lathering), skin glosser stick, skin makeup, hair groom, eye shadow (liquid, pomade, powder, stick, pressed or cream), eye liner, cologne stick, cologne, cologne emollient, bubble bath, body lotion (moisturizing, cleansing, analgesic, astringent), after shave lotion, after bath milk and sunscreen lotion.

For a description of various pigment applications, see Temple C. Patton, editor, The Pigment Handbook, volume II, Applications and Markets, John Wiley and Sons, New York (1973). In addition, see for example, with regard to ink: R. H. Leach, editor, The Printing Ink Manual, Fourth Edition, Van Nostrand Reinhold (International) Co. Ltd., London (1988), particularly pages 282-591; with regard to paints: C. H. Hare, Protective Coatings, Technology Publishing Co., Pittsburgh (1994), particularly pages 63-288. The foregoing references include teachings of ink, paint and plastic compositions, formulations and vehicles in which the embodiments described herein may be used including amounts of colorants. For example, the pigment may be used at a level of 10 to 15% in an offset lithographic ink, with the remainder being a vehicle containing gelled and ungelled hydrocarbon resins, alkyd resins, wax compounds and aliphatic solvent. The pigment may also be used, for example, at a level of 1 to 10% in an automotive paint formulation along with other pigments which may include titanium dioxide, acrylic lattices, coalescing agents, water or solvents. The pigment may also be used, for example, at a level of 20 to 30% in a plastic color concentrate in polyethylene.

Chroma: L*, a*, and b* data are described in Richard S. Hunter, The Measurement of Appearance, John Wiley & Sons, 1987. These CIELab measurements characterize the appearance of the product in terms of its lightness-darkness component, represented by L*, a red-green component represented by a*, and a yellow-blue component represented by b*.

### EXPERIMENTAL EXAMPLES

The chemicals used in the experiments include the following: PRO Scarlet 300 MX Reactive Dye: from Pro Chemical & Dye (Somerset, Mass.); PRO Deep Black 609 MX Reactive Dye: from Pro Chemical & Dye (Somerset, Mass.); PRO Intense Blue 406 MX Reactive Dye: from Pro Chemical & Dye (Somerset, Mass.); PRO Deep Navy 414 MX Reactive Dye: from Pro Chemical & Dye (Somerset, Mass.); PRO Sun Yellow 108 MX Reactive Dye: from Pro Chemical & Dye (Somerset, Mass.); PRO Intense Blue 406 MX Reactive Dye: from Pro Chemical & Dye (Somerset, Mass.); PRO Strong Orange 202 MX Reactive Dye: from Pro Chemical & Dye (Somerset, Mass.); PRO Golden Yellow 104 MX Reactive Dye: from Pro Chemical & Dye (Somerset, Mass.); PRO Grape 801 MX Reactive Dye: from Pro Chemical & Dye (Somerset, Mass.); 3-aminopropyltrimethoxy silane: from Gelest (Morrisville, Pa.); Silicon dioxide: from Sigma Aldrich (St. Louis, Mo.); Diatomaceous Earth: from Grefco Minerals, Inc. (Burney, Calif.); Triethoxy isocyano silane: from Gelest (Morrisville, Pa.); Branched Polyethylenimine: from Sigma Aldrich (St. Louis, Mo.); Isopropanol: from Sigma Aldrich (St. Louis, Mo.); Trimethoxysilylpropyl(polyethylenimine); Ammonium Hydroxide: from Sigma Aldrich (St. Louis, Mo.); Triethyl Amine: from Sigma Aldrich (St. Louis, Mo.); Sodium Chloride: from Sigma Aldrich (St. Louis, Mo.); Cibacron Black W-RKM NEW Dye: from Ciba; Cibacron Red FN-2BL Dye: from Ciba; Chitosan: Chitoclear CG400 from Primex (Siglufjordur, Iceland); Calcium Carbonate: from Spectrum Chemicals (Gardena, Calif.); FD&C Blue Dye No. 2: from Spectrum Chemicals (Gardena, Calif.); Eastman Polymer Dye: from Eastman Chemical Company (Kingsport, Tenn.); Firemist™ Pearl: from Engelhard Corporation (now BASF Catalysts) (Iselin, N.J.); Firemist™ Gold: from Engelhard Corporation (now BASF Catalysts) (Iselin, N.J.); Kaolin: from Engelhard Corporation (now BASF Catalysts) (Iselin, N.J.); Magna Pearl 3100: from Engelhard Corporation (now BASF Catalysts) (Iselin, N.J.); and Reflecks™ Dimensions: from Engelhard Corporation (now BASF Catalysts) (Iselin, N.J.).

### Example 1

### Kaolin Pigments

Kaolin pigments of various colors were prepared by mixing 5 g of kaolin, 1.0 mL of trimethoxy aminopropyl silane, and 0.2 g of MX reactive dye into 100 mL of deionized water. The reaction was left for six hours and then the pigments were filtered and washed with deionized water until all of the unbound dye was removed from the pigments. After drying overnight, pigments which were the color of the reactive dye were obtained. MX Reactive dyes used in this example include PRO Scarlet 300, PRO Deep Navy 414, PRO Sun Yellow 108, PRO Intense Blue 406, PRO Strong Orange 202, PRO Golden Yellow 104, and PRO Grape 801.

### Example 2

### Nacreous Pigments

Nacreous pigments of various colors were prepared by mixing 5 g of Reflecks™ Dimensions shimmering particles, 1.0 mL of trimethoxy aminopropyl silane, and 0.2 g of MX reactive dye into 100 mL of deionized water. The reaction was left for six hours and then the pigments were filtered and washed with deionized water until all of the unbound dye was removed from the pigments. After drying overnight, pigments which were the color of the reactive dye were obtained. MX Reactive dyes used in this example include PRO Scarlet 300 on shimmering red, PRO Deep Navy 414 on shimmering blue, PRO Intense Blue 406 on shimmering blue, PRO Scarlet 300 on shimmering blue, and PRO Grape 801 on shimmering white.

### Example 3

### Silica Pigments

Silica pigments that were blue in color were prepared by mixing 5 g of silicon dioxide particles (having an average diameter of approximately 14-15 nm), 1.0 mL of trimethoxy aminopropyl silane, and 0.2 g of PRO Intense Blue 406 MX reactive dye into 100 mL of deionized water. The reaction was left for six hours and then the pigments were filtered and washed with deionized water until all of the unbound dye was removed from the pigments. After drying overnight, blue pigments were obtained.

### Example 4

### Diatomaceous Earth Pigments

Diatomaceous earth pigments that were yellow in color were prepared by mixing 5 g of diatomaceous earth, 1.5 mL of trimethoxy aminopropyl silane, and 0.2 g of PRO Golden Yellow 104 MX reactive dye into 100 mL of deionized water. The reaction was left for six hours and then the pigments were filtered and washed with deionized water until all of the unbound dye was removed from the pigments. After drying overnight, yellow pigments were obtained.

### Example 5

### Polymer Decorated Kaolin, BPEI

Particles of Kaolin were functionalized with branched polyethylenimine by reacting 5 g of Kaolin and 1.0 mL triethoxy isocyano silane in 100 mL deionized water and 0.5 mL of ammonium hydroxide. The reaction was left overnight, and 0.5 g polyethylenimine was then added to the slurry. The particles were filtered and washed 3× with deionized water and 1× with isopropanol after 3 hours.

### Example 6

### Polymer Decorated Kaolin, LPEI

Particles of Kaolin were functionalized with linear polyethylenimine by reacting 2.5 g of Kaolin and 1.0 mL trimethoxysilylpropyl(polyethylenimine) (50% in isopropanol) in 100 mL deionized water. The particles were left reacting overnight and then filtered and washed 3× with deionized water and 1× with isopropanol after 3 hours.

### Example 7

### Polymer Decorated Diatomaceous Earth, BPEI

Particles of diatomaceous earth were functionalized with branched polyethylenimine by reacting 5 g of diatomaceous earth and 1.5 mL triethoxy isocyano silane in 100 mL deionized water and 0.75 mL of ammonium hydroxide. The reaction was left overnight, and 0.5 g polyethylenimine was then added to the slurry. The particles were filtered and washed 3× with deionized water and 1× with isopropanol after 3 hours.

### Example 8

### Polymer Decorated Silica, BPEI

Particles of silica were functionalized with branched polyethylenimine by reacting 5 g of 15 nm silicon dioxide and 1.0 mL triethoxy isocyano silane in 100 mL deionized water and 0.5 mL of ammonium hydroxide. The reaction was left overnight, and 0.5 g polyethylenimine was then added to the slurry. The particles were filtered and washed 3× with deionized water and 1× with isopropanol after 3 hours.

### Example 9

### Kaolin Hybrid Pigments (BPEI)

The kaolin pigments from example 1 were mixed with 1.0 mL triethoxy isocyano silane in 100 mL deionized water and 0.5mL of ammonium hydroxide. The reaction was left overnight, and 0.5 g polyethylenimine was then added to the slurry. The particles were filtered and washed 3× with deionized water and 1× with isopropanol after 3 hours. The BPEI-particles was used to react to a reactive dye and showed a color change from the additive effects of the two colors. For example, yellow particles were subjected to a reactive blue dye to yield a green particle.

### Example 10

### Kaolin Hybrid Pigments (LPEI)

The kaolin pigments from example 1 were mixed with 1.0 mL trimethoxysilylpropyl(polyethylenimine) (50% in isopropanol) in 100 mL deionized water. The particles were left reacting overnight and then filtered and washed 3× with deionized water and 1× with isopropanol after 3 hours.

### Example 11

### Nacreous Hybrid Pigments (BPEI)

The nacreous pigments from example 2 were mixed with 1.0 mL triethoxy isocyano silane in 100 mL isopropanol. The reaction stirred for 1 hour, and 0.5 g polyethylenimine was then added to the slurry. After 3 hours the particles were filtered and washed 3× with deionized water and 1× with isopropanol.

### Example 12

### Dye Attachment Under Basic Conditions (Triethyl Amine)

Into a 125 mL Erlenmeyer flask was placed 10.007 g of Magna Pearl 3100, 75 mL of DI water and a magnetic stir bar. To this was added 0.049 mL (0.5%) of 3-aminopropyltrimethoxysilane along with 0.067 mL of triethylamine and 0.076 g of PRO Deep Black 609 MX Reactive Dye while stirring. The reaction was allowed to proceed for 4 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 13

### Dye Attachment Under Basic Conditions (Ammonium Hydroxide)

Into a 125 mL Erlenmeyer flask was placed 10.042 g of Magna Pearl 3100, 75 mL of DI water and a magnetic stir bar. To this was added 0.049 mL (0.5%) of 3-aminopropyltrimethoxysilane along with 0.067 mL of ammonium hydroxide and 0.074 g of PRO Deep Black 609 MX Reactive Dye while stirring. The reaction was allowed to proceed for 4 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 14

### Dye Attachment Under Basic Conditions (Pre-Soaking Particles in Base to Create Excess Hydroxyls on Surface)

Into a 125 mL Erlenmeyer flask was placed 10.042 g of Magna Pearl 3100, 75 mL of DI water and a magnetic stir bar; also 0.050 mL (0.5%) of ammonium hydroxide which was allowed to stir for five minutes. To this was added 0.049 mL (0.5%) of 3-aminopropyltrimethoxysilane along with 0.067 mL of triethylamine and 0.074 g of PRO Deep Black 609 MX Reactive Dye while stirring. The reaction was allowed to proceed for 4 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 15

### Dye Attachment Under Basic Conditions (Saturated Brine (Salt Solution) to Mask Charges on Surface)

Into a 500 mL Round Bottom flask was placed 30.021 g of Magna Pearl 3100, 300 mL of DI water, and a magnetic stir bar. To this was added 1.5 mL (5%) of 3-aminopropyltrimethoxysilane, along with 1.017 g (0.25 equivalent to the silane) of PRO Deep Black 609 MX Reactive Dye, and 36.885 g of NaCl, while stirring. The reaction was allowed to proceed for 21 h. Samples were taken at ½ h, 1 h, 2 h, 3 h, and 21 h. Samples were filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 16

### Dye Attachment Under Basic Conditions (Isopropanol—Water Mixtures to Force Alcohol Insoluble Dye on Surface)

Into a 100 mL Round Bottom flask was placed 10.004 g of Magna Pearl 3100, 50 mL of a 50:50 IPA and DI water solution, and a magnetic stir bar. To this was added 4.9 ML (50%) of 3-aminopropyltrimethoxysilane along with 4.5 g of Cibacron Black W-RKM NEW Dye while stirring. The reaction was allowed to proceed for 2 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 17

### Dye Attachment Under Basic Conditions (Isopropanol—Water Mixtures to Force Alcohol Insoluble Dye on Surface)

Into a 100 mL Round Bottom flask was placed 10.017 g of Magna Pearl 3100, 50 mL of a 70:30 IPA and DI water solution, and a magnetic stir bar. To this was added 0.97 mL (10%) of 3-aminopropyltrimethoxysilane along with 1.5 g of Cibacron Black W-RKM NEW Dye while stirring. The reaction was allowed to proceed for 6.75 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 18

### Dye Attachment Under Basic Conditions (Higher Dye Loading (15%))

Into a 100 mL Round Bottom flask was placed 10.017 g of Magna Pearl 3100, 50 mL of DI water, and a magnetic stir bar. To this was added 1.45 mL (15%) of 3-aminopropyltrimethoxysilane along with 1.7 g (0.40 equivalent to the silane) of Cibacron Black W-RKM NEW Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 19

### Dye Attachment Under Basic Conditions (Higher Dye Loading (15%) in IPA:Water Mixture)

Into a 100 mL Round Bottom flask was placed 10.020 g of Magna Pearl 3100, 50 mL of a 70:30 IPA and DI water solution, and a magnetic stir bar. To this was added 1.45 ML (15%) of 3-aminopropyltrimethoxysilane along with 1.7 g (0.40 equivalent to the silane) of Cibacron Black W-RKM NEW Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 20

### Dye Attachment Under Basic Conditions (Higher Dye Loading (20%) Creates Darker and Intense Colored Pigment)

Into a 100 mL Round Bottom flask was placed 10.003 g of Magna Pearl 3100, 50 mL of DI water, and a magnetic stir bar. To this was added 1.94 mL (20%) of 3-aminopropyltrimethoxysilane along with 2.2 g (0.40 equivalent to the silane) of Cibacron Black W-RKM NEW Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 21

### Dye Attachment Under Basic Conditions (Higher Dye Loading (20%) in IPA:Water Mixture)

Into a 100 mL Round Bottom flask was placed 10.035 g of Magna Pearl 3100, 50 mL of a 50:50 IPA and DI water solution, and a magnetic stir bar. To this was added 1.94 mL (20%) of 3-aminopropyltrimethoxysilane along with 2.2 g (0.40 equivalent to the silane) of Cibacron Black W-RKM NEW Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 22

### Dye Attachment Under Basic Conditions (Higher Dye Loading (20%) in IPA:Water Mixture)

Into a 100 mL Round Bottom flask was placed 10.021 g of Magna Pearl 3100, 50 mL of a 70:30 IPA and DI water solution, and a magnetic stir bar. To this was added 1.94 mL (20%) of 3-aminopropyltrimethoxysilane along with 2.2 g (0.40 equivalent to the silane) of Cibacron Black W-RKM NEW Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 23

### Dye Attachment Under Basic Conditions (Higher Dye Loading (20%) in IPA:Water Mixture)

Into a 100 mL Round Bottom flask was placed 10.021 g of Magna Pearl 3100, 50 mL of a 70:30 IPA and DI water solution, and a magnetic stir bar. To this was added 1.94 mL (20%) of 3-aminopropyltrimethoxysilane along with 2.2 g (0.40 equivalent to the silane) of Cibacron Black W-RKM NEW Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 24

### Chitosan as a Binder Polymer (Can Be Used on Non-Traditional Particle Substrates)

Into a 100 mL Erlenmeyer flask was placed 20.0 g of precipitated (PCC) calcium carbonate, 100 mL of DI water, and a magnetic stir bar. To this was added 20 mL 2% aqueous solution of chitosan. The slurry became momentarily thick as the polymer wraps the particles. Continuous stirring provides a slurry that has a similar viscosity to the as the original slurry prior to addition of the polymer as stirring mechanically disrupts loose bridging or agglomeration may form. If excess polymer is used, raising the pH to 8 insures that the chitosan is out of the solution. Reaction product was filtered and washed with water until filtrate was neutral, then washed with isopropyl alcohol to remove water. Filtrate was placed into a vacuum oven at 55° C.

### Example 25

### Chitosan Coated Calcium Carbonate—Reactive Dye

Into a 100 mL Round Bottom flask was placed 2.0 g of 2% chitosan coated calcium carbonate (Example 25), 50 mL of DI water, and a magnetic stir bar. To this was added 0.205 g of Cibacron Black W-RKM Dye while stirring. The reaction was allowed to proceed for 2 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 26

### Chitosan Coated Calcium Carbonate—Static Food Dye

Into a 100 mL Round Bottom flask was placed 2.0 g of 2% coated calcium carbonate (Example 25), 30 mL of DI water, and a magnetic stir bar. To this was added 0.21 g of FD&C Blue Dye No. 2 while stirring. The reaction was allowed to proceed for 5 h. Reaction product was filtered and washed with water until filtrate was clear, then washed with isopropyl alcohol to remove water. Filtrate was placed into a vacuum oven at 55° C.

### Example 27

### Charged Chitosan Coated Calcium Carbonate—Static Food Dye

About 2 g of the particles prepared in Example 25 [2% coated calcium carbonate] were placed into a 100 mL Erlenmeyer flask with 30 mL of DI water and a magnetic stir bar. To this was added 1 mL of 0.01M HCl aqueous solution to charge the surface of the pigment particles. To this slurry was added 0.21 g of FD&C Blue Dye No. 2 while stirring. The reaction was allowed to proceed for 5 h. Reaction product was filtered and washed with water until filtrate was clear, then washed with isopropyl alcohol to remove water. Filtrate was placed into a vacuum oven at 55° C.

### Example 28

### Charged Chitosan Coated Calcium Carbonate—Static Polymer Dye

Into a 100 mL Round Bottom flask was placed 2.0 g of the particles prepared in Example 25 [2% coated calcium carbonate] and 30 mL of DI water. To this was added 1 mL of 0.01 M HCl aqueous solution to charge the surface of the pigment particles. To this slurry was added 0.31 g of polymer dye made by Eastman while stirring. The reaction was allowed to proceed for 2 h. Reaction product was filtered and washed with water until filtrate was clear, then washed with isopropyl alcohol to remove water. Filtrate was placed into a vacuum oven at 55° C.

### Example 29

### Charged Chitosan Coated Calcium Carbonate—Static Polymer Dye

Into a 100 mL Round Bottom flask was placed 2.0 g of 2% coated calcium carbonate, 50 mL of 0.1 N HCl in IPA. This solution was filtered and washed. This powder was then added to a round bottom flask and to this was added 0.31 g of polymer dye made by Eastman while stirring. The reaction was allowed to proceed for 2 h. Reaction product was filtered and washed with water until filtrate was clear, then washed with isopropyl alcohol to remove water. Filtrate was placed into a vacuum oven at 55° C.

### Example 30

### “E-19a”—Sample Measured for Color

Into a 125 mL Erlenmeyer flask was placed 10.009 g of Firemist™ Gold as described in Table 1 below, 50 mL of DI water and a magnetic stir bar. To this was added 0.97 mL (10%) of 3-aminopropyltrimethoxysilane along with 1.807 g of PRO Sun Yellow 108 MX Reactive Dye was added, while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 31

### “E-21b”—Sample Measured for Color

E21-B: Into a 125 mL Erlenmeyer flask was placed 10.072 g of Firemist™ Pearl as described in Table 1 below, 50 mL of DI water and a magnetic stir bar. To this was added 0.49 mL (5%) of 3-aminopropyltrimethoxysilane along with 0.904 g of PRO Deep Black 609 MX Reactive Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 32

### “E-28g”—Sample Measured for Color

E28-G: Into a 100 mL Round Bottom Flask was placed 5.026 g of Firemist™ Pearl, 50 mL of DI water and a magnetic stir bar. To this was added 0.049 mL (1%) of 3-aminopropyltrimethoxysilane along with 0.09 g of PRO Intense Blue 406 MX Reactive Dye and NaCl until saturated, while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was allowed to dry overnight.

### Example 33

### “E-28h”—Sample Measured for Color

E28-H: Into a 100 mL Round Bottom Flask was placed 5.01 g of Firemist™ Pearl, 50 mL of DI water and a magnetic stir bar. To this was added 0.246 mL (5%) of 3-aminopropyltrimethoxysilane along with 0.45 g of PRO Intense Blue 406 MX Reactive Dye and NaCl until saturated, while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was allowed to dry overnight.

### Example 34

### “E-28i”—Sample Measured for Color

E28-I: Into a 100 mL Round Bottom Flask was placed 5.026 g of Firemist™ Pearl, 50 mL of DI water and a magnetic stir bar. To this was added 0.49 mL (10%) of 3-aminopropyltrimethoxysilane along with 0.92 g of PRO Intense Blue 406 MX Reactive Dye and NaCl until saturated, while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was allowed to dry overnight.

### Example 35

### “E-33E”—Sample for Thermal Analysis

E33-E: Into a 100 mL Round Bottom flask was placed 10.004 g of Magna Pearl 3100, 50 mL of a 70:30 IPA and DI water solution, and a magnetic stir bar. To this was added 0.97 mL (10%) of 3-aminopropyltrimethoxysilane along with 1.8 g (0.65 equivalent to the silane) of Cibacron Black W-RKM NEW Dye while stirring. The reaction was allowed to proceed for 6.75 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 36

### “E-33F”—Sample for Thermal Analysis

E33-F: Into a 100 mL Round Bottom flask was placed 10.004 g of Magna Pearl 3100, 50 mL of a 70:30 IPA and DI water solution, and a magnetic stir bar. To this was added 0.97 mL (10%) of 3-aminopropyltrimethoxysilane along with 0.70 g (0.25 equivalent to the silane) of Cibacron Black W-RKM NEW Dye while stirring. The reaction was allowed to proceed for 23.25 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 37

### “E-34C”—Sample for Thermal Analysis

E34-C: Into a 100 mL Round Bottom flask was placed 10.045 g of Firemist™ Pearl, is 50 mL of DI water, and a magnetic stir bar. To this was added 0.97 mL (10%) of 3-aminopropyltrimethoxysilane along with 0.7 g (0.25 equivalent to the silane) of Cibacron Red FN-2BL Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

### Example 38

### “E-32A”—Sample for Thermal Analysis

E32-A: Into a 100 mL Round Bottom flask was placed 10.009 g of Firemist™ Gold, 50 mL of DI water, and a magnetic stir bar. To this was added 0.97 mL (10%) of 3-aminopropyltrimethoxysilane along with 1.807 g of PRO Sun Yellow 108 MX Reactive Dye while stirring. The reaction was allowed to proceed for 5 h. Reaction product was filtered and (i) washed with water until filtrate was clear; then (ii) washed with brine till filtrate was clear; then (iii) washed with water to rinse away brine; then (iv) washed with isopropyl alcohol to remove water. The filtrate was placed into a vacuum oven at 55° C.

Discussion

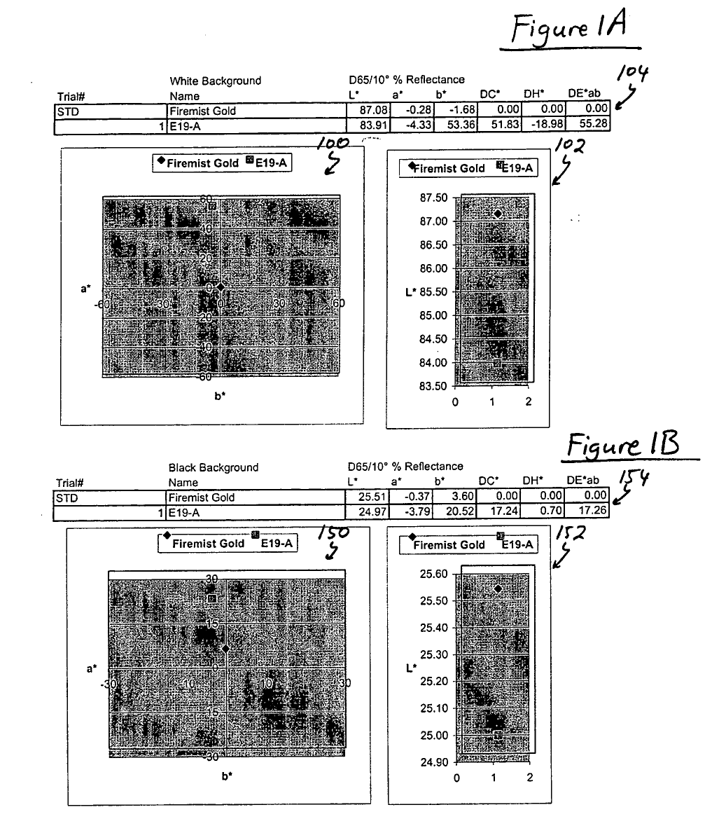

FIG. 1A shows two graphs 100, 102, the data for which are shown at reference 104, depicting calorimeter readings indicating the effect on pigment color made by the attachment of sun yellow reactive dye to Firemist™ Gold pigment particles via multifunctional coupling agent (3-aminopropyl trimethoxysilane) prepared in Example 30 (colorimeter readings made against a white background). The samples labeled “Firemist Gold” in FIGS. 1A and 1B were not reacted with multifunctional coupling agent and dye, for purposes of comparison. The L*a*b* color space (CIELAB) presents a three-dimensional rectangular coordinate system in which L* defines the lightness/darkness of the color, a* defines the greenness/redness of the color, and b* defines the yellowness/blueness of the color. The combination of L*, a*, and b* can be used to define the relationship between colors and as a quality control tool. In FIG. 1A, graphs 100 and 102 indicate a change in color due to attachment of reactive dye to the pigment particles. Here, the brightness (whiteness) decreased and the yellow coordinate increased, due to the attachment of the reactive dye.

FIG. 1B shows two graphs 150, 152, the data for which are shown at reference 154, depicting calorimeter readings indicating the effect on pigment color made by the attachment of sun yellow reactive dye to Firemist™ Gold pigment particles via multifunctional coupling agent (3-aminopropyl trimethoxysilane) prepared in Experimental Example 30 and labeled as E-19A, this time with calorimeter readings made against a black background. Again, this data shows brightness (whiteness) decreased and the yellow coordinate increased, due to the attachment of the reactive dye to the particles.

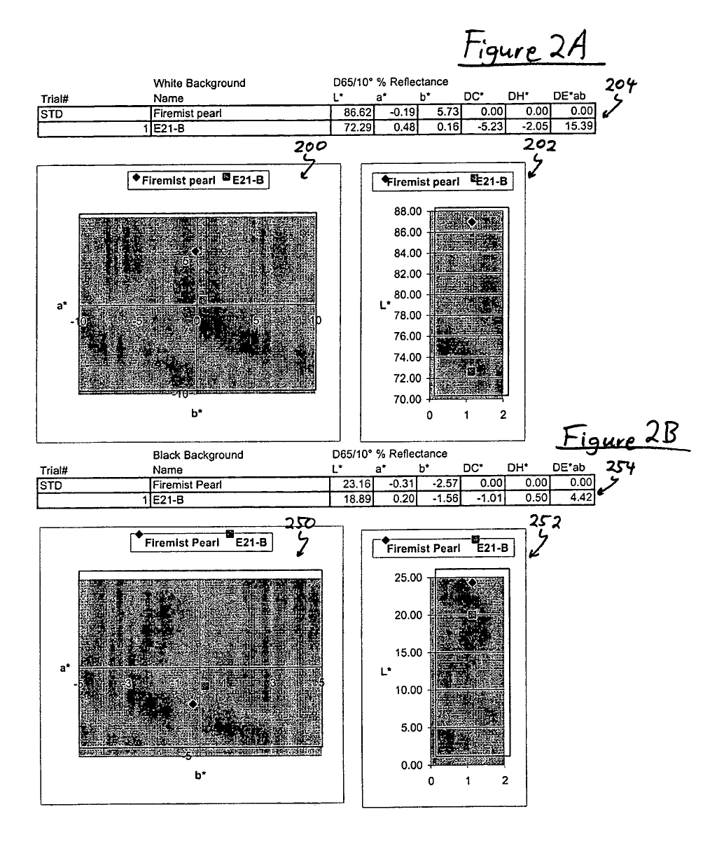

FIG. 2A shows two graphs 200, 202, the data for which are shown at reference 204, depicting colorimeter readings indicating the effect on pigment color made by the attachment of deep black 609 reactive dye to Firemist™ Pearl pigment particles via multifunctional coupling agent (3-aminopropyl trimethoxysilane) prepared in Experimental Example 31 and labeled E21-B, where the colorimeter readings are made against a white background. The samples labeled “Firemist Gold” in FIGS. 2A and 2B were not reacted with multifunctional coupling agent and dye, for purposes of comparison. In FIG. 2A, graphs 200 and 202 indicate a change in color due to attachment of reactive dye to the pigment particles. Here, the brightness (whiteness) decreased and the b coordinate is lowered to baseline, due to the attachment of the reactive dye to the particles.

FIG. 2B shows two graphs 250, 252, the data for which are shown at reference 254, depicting colorimeter readings indicating the effect on pigment color made by the attachment of deep black 609 reactive dye to Firemist™ Pearl pigment particles via multifunctional coupling agent (3-aminopropyl trimethoxysilane) prepared in Experimental Example 31 and labeled E21-B, this time with calorimeter readings made against a black background. This data shows the brightness (whiteness) decreased and the a and b coordinates are relatively unchanged from the original.

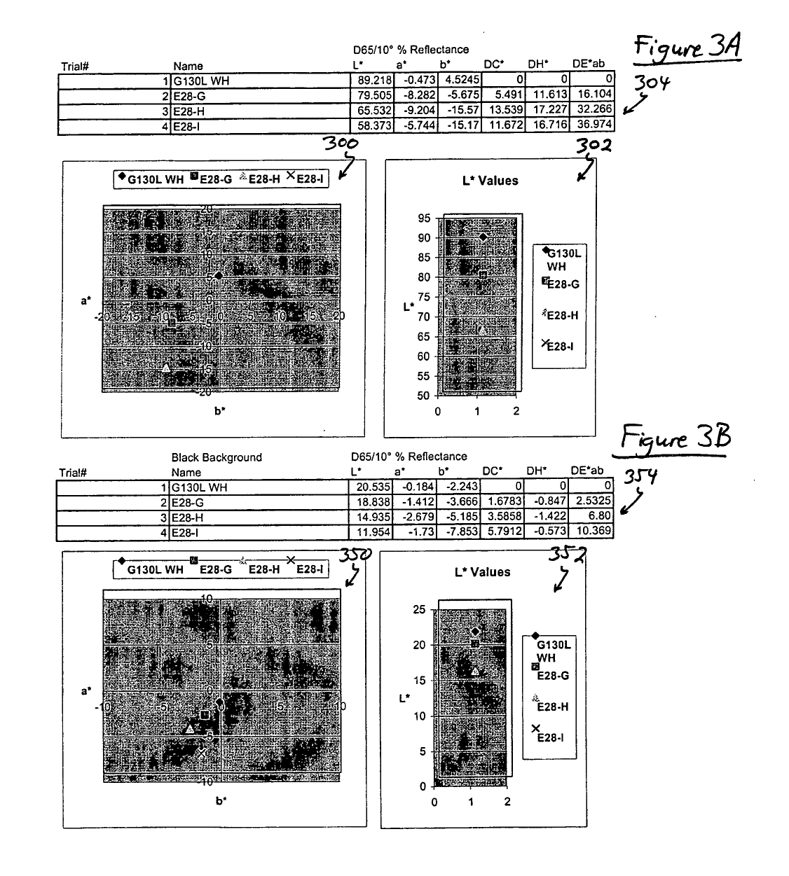

FIG. 3A shows two graphs 300, 302, the data for which are shown at reference 304, depicting colorimeter readings indicating the effect on pigment color made by the attachment of PRO Intense Blue 406 MX reactive dye to Firemist™ Pearl pigment particles B130L WH via multifunctional coupling agent (3-aminopropyl trimethoxysilane) prepared in Experimental Examples 32, 33, and 34, where calorimeter readings are made against a white background. Experimental Examples 32, 33, and 34 use increasing amounts of dye (1% in E28-G, 5% in E28-H, and 10% in E28-I) and increasing amounts of coupling agent. The data indicates that increased amounts of dye and coupling agent result in a decrease in the brightness (whiteness). The Firemist™ Pearl pigment paritlces G130L WH in FIGS. 3A and 3B were not reacted with multifunctional coupling agent and dye, for purposes of comparison. This indicates that higher loading of dye onto particle was achieved by contacting higher concentrations of dye with the particles.

FIG. 3B shows two graphs 350, 352, the data for which are shown at reference 354, depicting colorimeter readings indicating the effect on pigment color made by the attachment of PRO Intense Blue 406 MX reactive dye to Firemist™ Pearl pigment particles via multifunctional coupling agent (3-aminopropyl trimethoxysilane) prepared in Experimental Examples 32, 33, and 34, where colorimeter readings are made against a black background. Experimental Examples 32, 33, and 34 use increasing amounts of dye (1%, 5%, and 10%) and increasing amounts of coupling agent. The data indicates that increased amounts of dye and coupling agent result in a decrease in the brightness (whiteness) and a decrease in the b value. This indicates that higher loading of dye onto particle was achieved by contacting higher concentrations of dye with the particles.

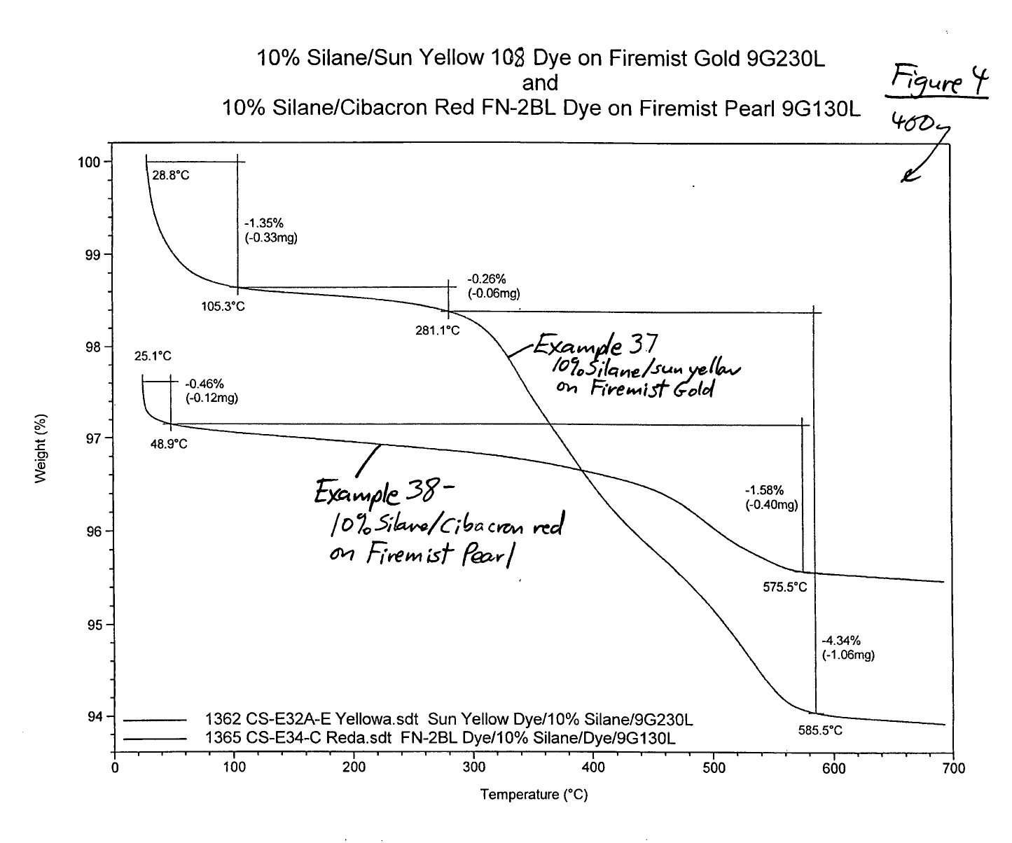

FIG. 4 shows a graph 400 depicting Thermal Gravimetric Analysis of two samples—(i) product of reaction of silane coupling agent, sun yellow 109 dye, and Firemist™ Gold (prepared in Experimental Example 37); and (ii) product of reaction of silane coupling agent, Cibacron Red FN-2BL dye, and Firemist™ Pearl pigment particles (prepared in Experimental Example 38)—indicating mass loss with increasing temperature. The weight loss of Example 37 appears to be about 4.34%. Since the theoretical loading of dye and coupling agent is 10%, it appears that not all of the dye and coupling agent burns away during heating. This is further evidence of the attachment of dye to the particle surface via the coupling agent. Also, it appears these samples contain some adsorbed moisture.

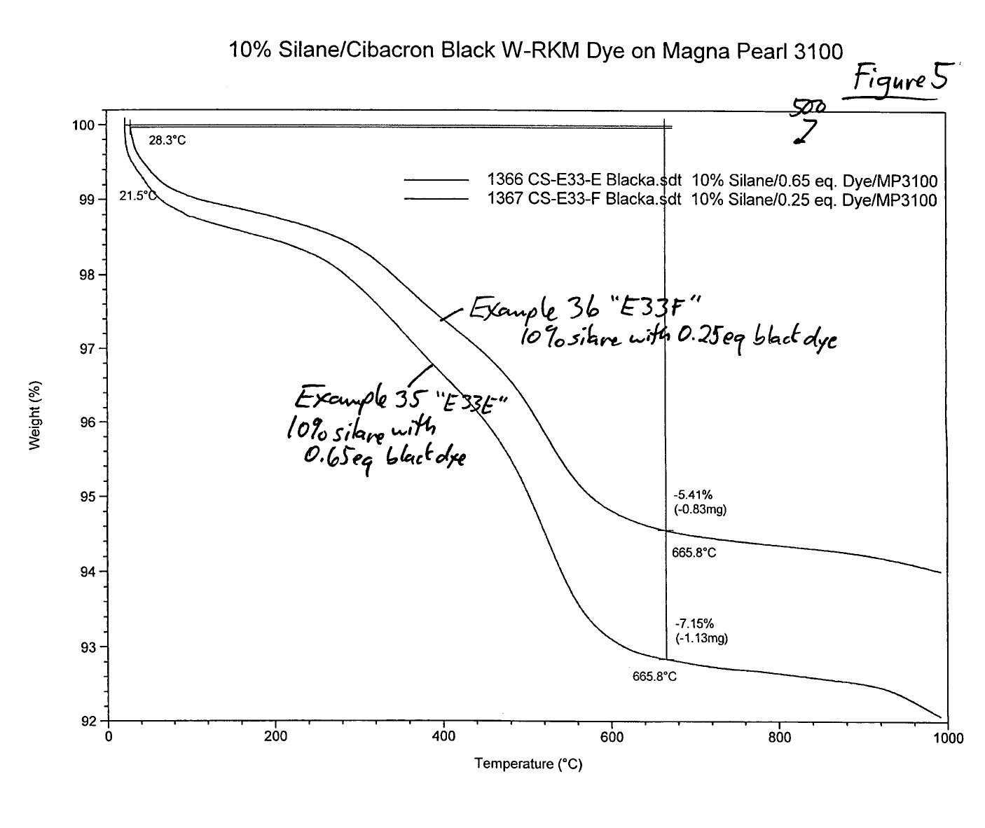

FIG. 5 shows a graph 500 depicting Thermal Gravimetric Analysis of two samples—(i) product of reaction of 10% silane coupling agent, 0.65 eq. Cibacron Black W-RKM dye, and Magna Pearl 3100 particles (prepared in Experimental Example 35; and (ii) product of reaction of 10% silane coupling agent, 0.25 eq. Cibacron Black W-RKM dye, and Magna Pearl 3100 particles (prepared in Experimental Example 36)—indicating mass loss with increasing temperature. The two examples have two different loadings of the reactive dye (0.25 eq and 0.65 eq with respect to the coupling agent). The weight loss appears to be higher with the example with higher loading of reactive dye. The graph 500 provides further evidence of the attachment of dye to the particle surface via the coupling agent. Also, it appears some of the weight loss may be associated with mica dehydroxylation (Magna Pearl 3100 substrate contains mica, not glass).

Table 1 is presented below to demonstrate the composition and particle sizes of various commercially available substrates, which may be used in various embodiments described herein. D10, D50, and D90 indicate percentage of particles (10%, 50%, 90%) below the indicated size. The size is indicative of the largest dimension of the particles (e.g. where particles are platelets, platelet thickness is lower than the sizes indicated in Table 1).

TABLE 1
Composition and particle size distribution of various commercially-available substrates

| | | | Particle Size | | |
|---|---|---|---|---|---|
| Name | Item # | Description | D10 | D50 | D90 |
| Firemist ™ Gold | 9G230L | calcium sodium borosilicate, titanium dioxide, | 43 μm | 94 μm | 174 μm |
| | | tin oxide | | | |
| Firemist ™ Pearl | 9G130L | calcium sodium borosilicate, titanium dioxide, | 43 μm | 94 μm | 174 μm |
| | | tin oxide | | | |
| Firemist ™ Red | 9G430L | calcium sodium borosilicate, titanium dioxide, | 43 μm | 94 μm | 174 μm |
| | | tin oxide | | | |
| Firemist ™ Turquoise | 9G730L | calcium sodium borosilicate, titanium dioxide, | 45 μm | 100 μm | 178 μm |
| | | tin oxide | | | |
| Flamenco Super Blue | 630Z | titanium dioxide, mica, tin oxide | 9 μm | 20 μm | 37 μm |
| Glass Beads | | Beads for highway stripes | | | |
| HT Pigment | | Kaolin | | | |
| Mearlin Firemist ™ Blue | 9G630L | Calcium sodium borosilicate, titanium | 43 μm | 94 μm | 174 μm |
| | | dioxide, tin oxide | | | |
| Mearlin Firemist ™ | 9G830L | Calcium sodium borosilicate, titanium | 43 μm | 94 μm | 174 μm |
| Green | | dioxide, titanium oxide | | | |
| Mearlin Manapearl 3100 | 3100 | Mica, titanium dioxide, tin oxide | (avg. 3.5 μm to 6.5 μm) | | |
| Mearlin Super Copper | 9350Z | Mica and iron oxide | (avg. 6 μm to 48 μm) | | |
| Prizmalite | P2453BTA | Ultra fine glass microspheres with aluminum | >80% is ˜38 μm | | |
| Raven 5000 | | Ultra Powder III carbon black | | | |
| Raven 5000 | 7800 | Carbon black | | | |
| Reflecks | G480D | Calcium sodium borosilicate, amorphous | 26 μm | 62 μm | 125 μm |
| MultiDimensions | | silica, titanium dioxide, tin oxide | | | |
| Changing Cherry | | | | | |
| Unipure Black | LC902 | Carbon black for cosmetics | | | |

| | | |
|---|---|---|
| Coslin H-200 kaolin | Kaolin | (avg. 0.3 μm to 0.5 μm) |
| Coslin C-100 kaolin | Kaolin | (avg. 0.7 μm to 0.9 μm) |
| Silicon dioxide (Sigma | silicon dioxide | (avg. 0.014 μm to |
| Aldrich, Experiment 3) | | 0.015 μm diameter) |

Preparation of Dye-Attached Pigments for Use in Consumer Formulations

### Example 39

10.0 grams of Firemist™ Gold (BASF Corporation) were placed into a 125 ml Erlenmeyer flask containing 50 ml of distilled water. The flask was mounted on a combination hot plate and magnetic stirring unit. The suspension was stirred using a magnetic stir bar. To the flask was added 0.97 ml of 3-aminopropyltrimethoxysilane along with 1.807 g of PRO Sun Yellow 108 MX Reactive Dye (available from PRO Chemical & Dye) was added, while stirring. The reaction was allowed to go for 5 h. Reaction was filtered and washed with water until filtrate was clear, then washed with brine till filtrate was clear and washed with water to rinse away brine. Then washed with isopropyl alcohol to remove water. Placed into vacuum oven at 55° C. Sample draw downs were created. The product obtained had a combination gold interference color with bulk yellow absorption coloration. The sample obtained had the color attributes shown in Table 2.

TABLE 2
Color attributes of sample prepared in Example 39

| | | | | | | | DE* |
|---|---|---|---|---|---|---|---|
| Trial # | Name | L* | a* | b* | DC* | DH* | AB |
| Standard | Firemist ™ | 87.08 | −0.28 | −1.68 | 0.00 | 0.00 | 0.00 |
| | Gold | | | | | | |
| | White | | | | | | |
| | Background | | | | | | |
| Standard | Firemist ™ | 25.51 | −0.37 | 3.60 | 0.00 | 0.00 | 0.00 |
| | Gold | | | | | | |
| | Black | | | | | | |
| | Background | | | | | | |
| 1 | Example 1 | 83.91 | −4.33 | 53.36 | 51.83 | −18.98 | 55.28 |
| | White | | | | | | |
| | Background | | | | | | |
| 1 | Example 1 | 24.97 | −3.79 | 20.52 | 17.24 | 0.70 | 17.26 |
| | Black | | | | | | |
| | Background | | | | | | |

Std Status: CREISS
Color Mode: L* a* b*
Observer: 10°
Primary Illuminant: D65

### Example 40

The product from Example 39 was molded into caps to assess the color attributes in polymeric applications. 1% by weight of pigment was mixed as a dry blend with general purpose polystyrene (PolyOne PS NPS3511) along with 0.1% zinc stearate and 0.1% mineral oil. The dry blend mixture was added directly into the hopper of a 25 ton hydraulic iinjection molding machine containing a 4-cavity cap mold operated at between 300-400° F. Visual inspection of the caps indicated good dispersion of the Example 39 product in the polymer and the coloration obtained was a gold interference effect along with a bright yellow bulk color. In a similar procedure, product from Example 39 was processed in polycarbonate (Lexan 141 R by GE, with post addition of 0.1% mineral oil), within a temperature range of 500-600° F.

### Example 41

The product from Example 39 was used to make an all purpose decorative powder as follows:

| PHASE INGREDIENTS | | % |
|---|---|---|
| A | Mearltalc ® TCA {Talc (and) Lauroyl | 70.00 |
| | Lysine-BASF}(q.s. to 100%) | |
| | Bi-Lite ® 20 BL1070 (mica (and) | 20.00 |
| | Bismuth Oxychloride-BASF} | |
| | Preservatives (q.s. = quantity | q.s. |
| | sufficient to total 100%) | |
| B | Flamenco ® Summit Gold Y30D | 8.00 |
| | {mica (and) titanium dioxide-BASF} | |
| | Example 39 sample | 2.00 |

PROCEDURE
I. Thoroughly blend Phase A in appropriate dry blending/dispersing equipment.
II. Pulverize and return to blender
III. Add Phase B to Phase A and tumble until uniform.

### Example 42

The product from Example 39 was incorporated into a personal care all purpose gloss cosmetic. The gloss was prepared from the following ingredients:

| PHASE INGREDIENTS | | % |
|---|---|---|
| A | Petrolatum (Fonoline-Crompton Corporation) | 62.15 |
| | Microcrystalline Wax (Multiwax 180W-Crompton Corporation) | 9.36 |
| | Isostearyl Linoleate (Protachem ISL-Protameen Chemicals) | 0.90 |
| | Tocopheryl Acetate (Vitamin E Acetate, USP-DSM Nutritional Products) | 0.44 |
| | Benzophenone-3 (Uvinul M 40-BASF) | 3.94 |
| | Ethylhexyl Methoxycinnamate (Parsol MCX-DSM Nutritional Products) | 6.90 |
| | Di-PPG-3 Myristyl Ether Adipate (Cromoleint DP3A-Croda, In.) | 2.96 |
| | C10-30 Cholesterol/Lanosterol Esters (Super Sterol Ester-Croda, Inc.) | 3.94 |
| B | Color Hydroxy-Salicylic Complex {Pentaerythrityl Tetraisostearate (and) | 4.94 |
| | Sodium Silicate (and) Sodium Stearate (and) Sodium Chloride-BASF} | |
| | Ethylhexyl Palmitate (Jeepchem OP-Jeen International Corporation) | 1.48 |
| | Preservatives | q.s. |
| | Antioxidants | q.s. |
| C | Example 39 sample | 3.0 |
| D | Fragrance | q.s. |

PROCEDURE
I. Weigh all Phase A ingredients in a vessel and heat to 87° C., stirring completely melted and uniform.
II. Reduce the temperature to 78° C. and add Phase B. Mix until homogeneous.
III. Add Phase C to Phase A-B.
IV. Stir slowly maintaining temperature to 78° C. Add Phase D and mix until homogeneous. Pour at 65° C.

### Example 43

The product of Example 39 was incorporated into a personal care all purpose stick cosmetic. The stick was prepared from the following ingredients:

| PHASE INGREDIENTS | | % |
|---|---|---|
| A | Beeswax (Cera Alba) | 8.30 |
| | Euphorbia Cerifera (Candelilla) Wax | 5.90 |
| | Ozokerite | 3.40 |
| | Diisopropyl Adipate (Schercemol DIA-Noveon, Inc.) | 9.00 |
| | Isopropyl Lanolate (Vilvanolin P-Chemron Corporation) | 9.00 |
| | Isostearyl Alcohol (Jeecol ISA-Jeen International, Inc.) | 9.40 |
| | Ethylhexyl Methoxycinnamate (Parsol MCX-DSM | 2.00 |
| | Nutritional Products) | |
| | Preservatives | q.s |
| B | Example 39 sample | 5.00 |
| | Mearlmica CF (Mica-BASF) | 5.00 |
| C | Ricinus Communis (Castor) Seed Oil | 43.00 |
| | Fragrance | q.s. |

PROCEDURE
I. Weigh all ingredients in a vessel and heat to 85° C., stirring until melted and uniform.
II. Add pre-mixed Phase B to Phase A, maintaining temperature at 85° C.
III. Add Phase C to Phase A-B, maintaining temperature at 85° C. for 30 minutes with gently agitation for deaeration.
IV. Pour into molds.

### Example 44

The product from Example 39 was incorporated into a nail enamel. The nail enamel was prepared as follows.

| PHASE INGREDIENTS | % |
|---|---|
| Suspending Lacquer SLF-2 {Butyl Acetate (and) Toluene | 97.00 |
| (and) Nitrocellulose (and) Tosylamide/Formaldehyde Resin | |
| (and) Isopropyl Alcohol (and) Dibutyl Phthalate (and) Ethyl | |
| Acetate (and) Camphor (and) n-Butyl Alcohol | |
| (and) Silica (and) Quaternium-18 Hectorite} | |
| Example 39 sample | 3.00 |

PROCEDURE
I. Combine all the components in an appropriate size vessel fitted with a Lightnin ™ type propeller mixer. Continue mixing until batch is uniform.

### Example 45

The product of Example 39 was incorporated into a shampoo. The shampoo was prepared from the following ingredients:

| PHASE INGREDIENTS | | % |
|---|---|---|
| A | DI Water (q.s. to 100%) | 70.14 |
| | Disodium EDTA (Versene NA-Dow Chemical Company) | 0.01 |
| | Acrylate Copolymers (30%) (Carbopol Aqua SF-1 | 7.50 |
| | Polymer-Noveon, Inc.) | |
| B | Disodium Laureth Sulfosuccinate (and) Ammonium | 20.00 |
| | Cocoyl Isethionate (and) Cocamidopropyl Betaine | |
| | (Chemoryl SFB-10K-Noveon, Inc.) | |
| C | Sodium Hydroxide (20%) (q.s. to pH = 6.75) | q.s. |
| D | Glydant Plus | 0.30 |
| E | DI Water | 2.00 |
| | Example 39 sample | 0.04 |
| | ReflecksTM Multidimensions Varying Violet G58D | 0.01 |
| | {Calcium Sodium Borosilicate (and) Silica (and) | |
| | Titanium Dioxide-BASF} | |

PROCEDURE
I. Dissolve EDTA into water with sweep mixing.
II. Add Carbopol SF-1 into DI water.
III. Slowly add surfactant blend to Phase A.
IV. Neutralize Phase A-B by adding NaOH drop by drop.
V. Add preservatives. Mix well.
VI. Add pigments and mix until uniform.

### Example 46

The product from Example 39 was incorporated into a soap formulation and was prepared as follows.

| PHASE INGREDIENTS | % |
|---|---|
| Clear Glycerin Soap Base | 99.90 |
| Example 1 sample | 0.10 |

PROCEDURE
I. Combine all the components in an appropriate size vessel with continuous mixing until batch is uniform.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A pigment comprising a particle with a dye attached to its surface via a first multifunctional coupling agent, the particle also having a polymer attached to its surface, wherein the polymer is either:
directly deposited onto the particle surface; or
attached to the particle surface via the first multifunctional coupling agent; or
attached to the particle surface via a second multifunctional coupling agent.

2. The pigment of claim 1, wherein the particle is less than about 10 μm in at least one dimension.

3. (canceled)

4. The pigment of claim 1, wherein the particle comprises a metal oxide, a semi-metal oxide, or both.

5.-6. (canceled)

7. The pigment of claim 1, wherein the particle comprises at least one member selected from the following: titanium dioxide, borosilicate, alumina, ferric oxide, mica, talc, glass, and nacreous pigment.

8.-9. (canceled)

10. The pigment of claim 1, wherein the first multifunctional coupling agent comprises Si and at least one member selected from the following: an amino group, an epoxy group, a hydroxyl group, a thiol group, a carboxyl group, an acrylate group, and an isocyano group.

11. The pigment of claim 1, wherein the dye comprises at least one of a halotriazine, a chlorotriazine, and a vinyl sulfone.

12. The pigment of claim 1, wherein the dye comprises at least one member selected from the following: a monohalogenotriazine, a dihalogenotrizine, a carboxypyridinium-substituted triazine, a trihalogenopyrimidizine, a dichloroquinoxaline, a fluorescent dye, a phosphorescent dye, a photochromic dye, a thermochromic dye, a whitener, a brightener, a light stabilizer, and a UV light stabilizer.

13. The pigment of claim 1, wherein the polymer comprises an amine group.

14. The pigment of claim 13, wherein the polymer comprises at least one member selected from the following: polyethyleneimine, linear polyethyleneimine, branched polyethyleneimine, poly(allyl amine), poly(vinyl amine), and chitosan.

15. (canceled)

16. The pigment of claim 1, wherein the polymer comprises a carboxyl group.

17. The pigment of claim 16, wherein the polymer comprises at least one member selected from the following: polyacrylic acid, polymethacrylic acid, carboxymethylcellulose, pectin, and xanthan gum.

18. The pigment of claim 1, wherein the polymer comprises at least one member selected from the following: poly(vinyl alcohol), polyethylene glycol, and a polysaccharide.

19.-20. (canceled)

21. A pigment comprising a particle with a dye attached to its surface via a multifunctional coupling agent, wherein the particle is less than about 10 μm in at least one dimension, the particle comprising a metal oxide, a semi-metal oxide, or both.

22. (canceled)

23. The pigment of claim 21, wherein the particle is less than about 200 nm in diameter.

24.-27. (canceled)

28. The pigment of claim 21, wherein the particle comprises at least one member selected from the following: titanium dioxide, borosilicate, alumina, ferric oxide, mica, talc, glass, and nacreous pigment.

29.-30. (canceled)

31. The pigment of claim 21, wherein the multifunctional coupling agent comprises Si and comprises at least one member selected from the following: an amino group, an epoxy group, a hydroxyl group, a thiol group, an acrylate group, a carboxyl group, and an isocyano group.

32.-41. (canceled)

42. The pigment of claim 2l, wherein the dye comprises a halotriazine.

43.-45. (canceled)

46. The pigment of claim 21, wherein the dye comprises at least one member selected from the following: a fluorescent dye, a phosphorescent dye, a photochromic dye, a thermochromic dye, a whitener, a brightener, a light stabilizer, and a UV light stabilizer.

47. The pigment of claim 21, wherein the particle has at least one of the following agents attached to its surface: a light stabilizer, a UV light stabilizer, a hindered amine light stabilizer, and a free radical scavenger.

48.-79. (canceled)

80. A pigment comprising:
a particle with a polymer attached to its surface, the polymer having a dye attached thereto, wherein the polymer is either:
directly deposited onto the surface of the particle; or
attached to the surface of the particle via a multifunctional coupling agent.

81. A pigment comprising a nacreous pigment with a dye attached to its surface via a multifunctional coupling agent.

82. The pigment of claim 80, wherein the particle is less than about 10 μm in at least one dimension.

83. The pigment of claim 80, wherein the particle comprises a metal oxide, a semi-metal oxide, or both.

84. The pigment of claim 80, wherein the particle comprises at least one member selected from the following: titanium dioxide, borosilicate, alumina, ferric oxide, mica, talc, glass, and nacreous pigment.

85. The pigment of claim 80, wherein the dye comprises at least one member selected from the following: a halotriazine, a chlorotriazine, and a vinyl sulfone.

86. The pigment of claim 80, wherein the dye comprises at least one member selected from the following: a monohalogenotriazine, a dihalogenotrizine, a carboxypyridinium-substituted triazine, a trihalogenopyrimidizine, a dichloroquinoxaline, a fluorescent dye, a phosphorescent dye, a photochromic dye, a thermochromic dye, a whitener, a brightener, a light stabilizer, and a UV light stabilizer.

87. The pigment of claim 80, wherein the polymer comprises an amine group.

88. The pigment of claim 87, wherein the polymer comprises at least one member selected from the following: polyethyleneimine, linear polyethyleneimine, branched polyethyleneimine, poly(allyl amine), poly(vinyl amine), and chitosan.

89. The pigment of claim 80, wherein the polymer comprises a carboxyl group.

90. The pigment of claim 89, wherein the polymer comprises at least one member selected from the following: polyacrylic acid, polymethacrylic acid, carboxymethylcellulose, pectin, and xanthan gum.

91. The pigment of claim 80, wherein the polymer comprises at least one member selected from the following: a poly(vinyl alcohol), polyethylene glycol, and a polysaccharide.

92. The pigment of claim 81, wherein the particle comprises a metal oxide, a semi-metal oxide, or both.

93. The pigment of claim 81, wherein the particle comprises an oxide of at least one member selected from the following: Si, Sn, Al, Ti, and Bi.

94. The pigment of claim 81, wherein the particle comprises an oxide of at least one member selected from the following: Fe, Zr, and Zn.

95. The pigment of claim 81, wherein the dye comprises at least one member selected from the following: a halotriazine, a chlorotriazine, and a vinyl sulfone.

96. The pigment of claim 81, wherein the dye comprises at least one member selected from the following: a monohalogenotriazine, a dihalogenotrizine, a carboxypyridinium-substituted triazine, a trihalogenopyrimidizine, a dichloroquinoxaline, a fluorescent dye, a phosphorescent dye, a photochromic dye, a thermochromic dye, a whitener, a brightener, a light stabilizer, and a UV light stabilizer.

97. The pigment of claim 81, wherein the multifunctional coupling agent comprises Si and comprises at least one member selected from the following: an amino group, an epoxy group, a hydroxyl group, a thiol group, an acrylate group, a carboxyl group, and an isocyano group.

98. The pigment of claim 81, wherein the multifunctional coupling agent comprises at least one of the following: an isocyanosilane, an aminosilane, and an epoxy siloxane.
